(19) United States
(12) Patent Application Publication
(10) Pub. No.: US 2024/0199326 A1
(43) Pub. Date: Jun. 20, 2024

(54) An Automated Load Handling System

(71) Applicant: Ocado Innovation Limited, Hatfield, Hertfordshire (GB)

(72) Inventors: Pawel KAROLINCZAK, Hatfield, Hertfordshire (GB); Lars Sverker Ture LINDBO, Hatfield, Hertfordshire (GB); Matthew WHELAN, Hatfield, Hertfordshire (GB); Andrew INGRAM-TEDD, Hatfield, Hertfordshire (GB)

(73) Assignee: Ocado Innovation Limited, Hatfield, Hertfordshire (GB)

(21) Appl. No.: 18/555,017

(22) PCT Filed: Apr. 13, 2022
(86) PCT No.: PCT/EP2022/059921

§ 371 Date: Oct. 12, 2023

(30) Foreign Application Priority Data
Apr. 14, 2021 (GB) 2105316.0

(51) Int. Cl. B65G 1/04; B65G 1/137

(52) U.S. Cl. CPC B65G 1/0464; B65G 1/0478; B65G 1/0492; B65G 1/1378; B65G 2203/0216; B65G 2203/0233; B65G 2203/0283

(57) ABSTRACT

An automated load handling system including: first and second automated storage and retrieval systems each having a grid framework structure, and plural robotic load handling devices; at least one port column through which a respective robotic load handling device is able to access storage containers; and at least one transfer system configured to transfer storage containers or items therein from a port column of the first automated storage and retrieval system to a port column of the second automated storage and retrieval system, and wherein grid openings of the first and second automated storage and retrieval systems are of different size.

### FIELD OF THE INVENTION

The present invention relates to an automated load handling system comprising automated storage and retrieval systems for handling storage containers or bins.

### INTRODUCTION

Some commercial and industrial activities require systems that enable the storage and retrieval of a large number of different products. Generally, warehouses for the storage and retrieval of products or items comprise a series of racks that are accessible by transport devices comprising a lifting device, such as forklifts, that are moveable within aisles between the racks. The products or items are typically stored on pallets or other storage containers and placed on different levels of the racks. A transport device, either manually driven or automated, travels up and down aisles between the racks and the lifting device is used to retrieve a pallet storing a particular product or item thereon from the racks. However, the storage and retrieval of products is very labour intensive and time consuming.

PCT Publication No. WO2015/185628A (Ocado) describes a known automated storage and retrieval system in which stacks of bins or containers are arranged within a grid framework structure. The containers, known as bins or storage bins or containers or storage containers, are stacked on top of one another to form stacks. The stacks are arranged in a grid framework structure in a warehousing or distribution centre. The bins or containers are accessed by robotic load handling devices (otherwise known as bots) remotely operative on tracks located on the top of the grid framework structure. Whilst the automated storage and retrieval system taught in WO2015/185628A (Ocado) provides for a very dense system for the storage of items, there is no ability of the automated storage and retrieval system to collate the bins or containers based on a particular attribute of the content of the bins or containers in storage.

For example, collation of the bins or containers is necessary where the industrial activity is a baggage handling system at an airport. Airport terminals around the world generally employ some form of system for checking in passengers' baggage, loading it in the cargo hold of a plane prior to the flight departing and returning the passengers' baggage at the end of their flight. The equipment required to provide this service, particularly at large international airports, can be quite extensive. Known baggage transportation systems used in airports may include a check-in system for departures and a collection system for arrivals.

An example of the passage of baggage at check-in and at collection at an airport may comprise the following. A passenger deposits their baggage at a check-in desk at the terminal. The passenger's baggage is then put on a conveyor which carries the baggage to a chute which guides the baggage to a build cell which may be located on a lower level of the building. Large international terminals may employ up to 200 or more build cells below their check-in area.

A build cell of the type used in such conventional baggage systems typically includes a conveyor for carrying baggage exiting the chute away from the chute exit.

One or more manual handling personnel are assigned to each build cell to remove the baggage from the conveyor and onto a loading station adjacent the conveyor. Each build cell is designated to collect baggage for a specified flight in order to avoid baggage being sent to an incorrect destination. A tug and dolly transporting system then pulls up alongside the loading station and the baggage is manually loaded into a unit-loading device (ULD), also known as a flight can or a baggage cart.

A ULD serves to allow large quantities of cargo to be bundled or collated into the one unit. This saves ground crew time and effort in the loading the plane as there are fewer individual units to handle. Once the ULD is loaded onto the tug and dolly, it is transported to the plane and, depending upon the particular aircraft, airline, and any applicable rules or regulations, the baggage is either stored on the aircraft in the ULD or is manually unloaded into the aircraft.

The baggage handling system described above suffers from a number of problems. The conveyor must be at ground level for the baggage to be moved to the loading station and picked up by the tug and dolly. Where multiple build cells are employed, a large surface area is taken up. Furthermore, check-in times for flights generally take up to approximately 3 hours. If the baggage sitting on the conveyor cannot be loaded into a ULD until check-in is complete for all passengers, that particular conveyor cannot be utilised to store baggage for any other flights during this time.

The transfer of the baggage from the base of the chute onto the baggage cart or ULD has been achieved by manual lifting and positioning. However, concerns have been raised about the injuries which can result from such manual effort.

An automated load handling system is thus required that does not suffer from the problems described above.

### SUMMARY OF THE INVENTION

The present invention has mitigated the above problem by providing an automated load handling system (also referred to as a load handling system or automated handling system) based on the high storage capacity of the storage and retrieval system described in the publication WO2015/185628A (Ocado). The 3-dimensional grid framework structure described in the publication WO2015/185628A (Ocado) has the ability to store a high density of items or storage containers over a given footprint of the grid framework structure in comparison to other storage and retrieval systems known in the art. To overcome the problem of the storage and retrieval system described WO2015/185628A (Ocado) having the ability to collate and/or sort one or more items in storage, the present invention provides an automated load handling system comprising:
A) a first and a second automated storage and retrieval system, each automated storage and retrieval system of the first and the second automated storage and retrieval system comprising:
   i) a grid framework structure comprising:
      a) a track system comprising a first set of parallel tracks and a second set of parallel tracks running transversely to the first set in a substantially horizontal plane and arranged in a grid pattern comprising a plurality of grid cells, each grid cell defining a grid opening defined by a pair of adjacent tracks of the first set of parallel tracks and a pair of adjacent tracks of the second set of parallel track,
      b) a plurality of storage columns, each storage column being arranged to store a respective stack of storage containers for storing one or more items, wherein the stack of storage columns are located beneath the track system such that each stack of storage containers occupies a single grid space or grid cell,
   ii) a plurality of robotic load handling devices operative on the track system for lifting and moving one or more storage containers from a stack,
B) at least one port column extending downwardly from a grid opening of the track system of each of the first and the second automated storage and retrieval system through which a respective robotic load handling device operative on the track system is able to drop off and pick up one or more storage containers;
characterised in that the automated load handling system further comprises:
C) at least one transfer system configured to transfer one or more storage containers or one or more items from the storage containers from the at least one port column of the first automated storage and retrieval system to the at least one port column of the second automated storage and retrieval system, and
wherein the grid openings of the track system of the first automated storage and retrieval system are a different size to the grid openings of the track system of the second automated storage and retrieval system such that the grid framework structure of the first automated storage and retrieval system is configured to store storage containers that are differently sized to the storage containers stored in the grid framework structure of the second automated storage and retrieval system.

By providing a first and a second automated storage and retrieval system, wherein each automated storage and retrieval system of the first and the second automated storage and retrieval system comprises a grid framework structure and a plurality of robotic load handling devices operative on the track system for lifting and moving one or more storage containers from a stack, the load handling device according to the present invention can take advantage of the high storage density and automation of their respective grid framework structures for the storage and retrieval of storage containers. To enable the automated load handling system of the present invention to sort and/or collate one or more storage containers or one or more items from the storage containers, the automated load handling system further comprises at least one transfer system that is configured to transfer one or more storage containers or one or more items from the storage containers from the first automated storage and retrieval system to the second automated storage and retrieval system. The relationship between the grid framework structure of the first automated storage and retrieval system and the grid framework structure of the second automated storage and retrieval system provided by the at least one transfer system allows storage containers or items from the storage containers to be retrieved from the first storage and retrieval system to be collated or consolidated or sorted in one or more storage containers prior to being stored in the second storage and retrieval system. In order to collate the one or more storage containers or items from the storage containers for storage in the second storage and retrieval system, the grid opening of the track system of the first automated storage and retrieval system is a different size to the grid opening of the track system of the second automated storage and retrieval system such that the grid framework structure of the first automated storage and retrieval system is configured to store storage containers that are differently sized to the storage containers stored in the grid framework structure of the second automated storage and retrieval system. This creates a mismatch of grid framework structures in the sense that each of the mismatched grid framework structures allows different sized storage containers to be stored in their respective mismatched grid framework structures and at least one transfer system is required to transfer the one or more storage containers or one or more items from the storage containers between the mismatched grid framework structures. For the purpose of the present invention, the size of the grid opening represents the diagonal length across a maximum grid opening of the track system when the robotic load handling device is moving across the track system. Preferably, the grid opening of the track system of the first automated storage and retrieval system is smaller than the grid opening of the track system of the second automated storage and retrieval system such that the grid framework structure of the first automated storage and retrieval system is configured to store smaller storage containers than the storage containers stored in the grid framework structure of the second automated storage and retrieval system.

Each respective grid framework structure of the first and second storage and retrieval systems comprises a track system comprising a first set of parallel tracks and a second set of parallel tracks running transversely to the first set of parallel tracks in the sense the first and second set of parallel tracks are arranged in a grid pattern lying in a horizontal plane comprising a plurality of grid spaces or grid cells having grid openings. Thus, the first set of parallel tracks guide a robotic load handling device in the X-direction and the second set of parallel tracks guide the robotic load handling device in the Y-direction.

The storage containers are stored in stacks in one or more storage columns of the respective grid framework structure of the first and second storage and retrieval systems, wherein each stack of storage containers is arranged to occupy a single grid space or grid cell. In this way, the openings of the grid cells or grid spaces correspond to the storage columns over which a load handling device operative on the track system can move laterally over each of the storage columns to retrieve a storage container in a stack.

Each of the plurality of robotic load handling devices comprises a vehicle body and a wheel assembly which is arranged to travel in the X and Y directions on the track system of the grid framework structure above the stacks. The wheel assembly comprises two sets of wheels which run on the track system. Each of the two sets of wheels is driven to enable movement of the vehicle in X and Y directions respectively along the tracks. A first set of wheels, consisting of a pair of wheels on the front of the vehicle and a pair of wheels on the back of the vehicle, is arranged to engage with two adjacent tracks of the first set of tracks. Similarly, a second set of wheels, consisting of a pair of wheels on each side of the vehicle, is arranged to engage with two adjacent tracks of the second set of tracks. When the first set of wheels is engaged with the first set of tracks and the second set of wheels is lifted clear from the tracks or rails, the wheels can be driven, by way of a drive mechanism housed in the vehicle body, to move the robotic load handling device in the X direction. To move the load handling device in the Y direction, the first set of wheels is lifted clear of the tracks or rails, and the second set of wheels is lowered into engagement with the second set of tracks or rails. The drive mechanism can then be used to drive the second set of wheels to achieve movement in the Y direction. One or both sets of wheels can be moved vertically to lift each set of wheels clear of the respective rails, thereby allowing the vehicle to move in the desired direction on the track system.

Additionally, each of the plurality of robotic load handling devices comprises a container receiving space for receiving and stowing a storage container when transporting the storage container across the top of the grid. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the robotic load handing device.

Each respective grid framework structure of the first and second storage and retrieval systems has at least one grid column which is not used for storing storage containers in a stack as the storage columns. Instead, the at least one grid column is used by a robotic load handling device to drop off and/or pick up storage containers so that they can be transferred to the at least one transfer system, where the contents of the storage containers can be accessed from the outside of the grid framework structure of the first storage and retrieval system and transferred to the grid framework structure of the second storage and retrieval system via the at least one transfer system. For the purpose of the present invention, the grid opening of the at least one grid column is termed a “port” and the at least one grid column where the port is located is termed “at least one port column”. The at least one port column extends downwardly from the grid opening of the track system of each of the first and the second automated storage and retrieval systems. Through the respective grid openings, a respective robotic load handling device operative on the track system is able to drop off and pick up one or more storage containers. Optionally, the at least one port column comprises two port columns, a first port column dedicated as a drop off port column and defined as an outlet port column where a robotic load handling device can drop off a storage container to the at least one transfer system, and a second port column dedicated as a pick up port column and defined as an inlet port column where the robotic load handling device can pick up a storage container delivered to the port column from the at least one transfer system.

Optionally, the at least one transfer system comprises a conveyor system comprising at least one conveyor unit extending from the port column of the grid framework structure of the first automated storage and retrieval system to the port column of the grid framework structure of the second automated storage and retrieval system so as to transport one or more storage containers from the first automated storage and retrieval system to the second automated storage and retrieval system. In this example, at least one conveyor unit extends between the port columns from the first and the second storage and retrieval systems such that storage containers can be transferred directly from the first storage and retrieval system to the second storage and retrieval system, where they can be collated based on an attribute of the contents of the storage containers, e.g. user details, flight number in the case of an airport baggage handling system.

To enable the transfer of the contents of the storage container from the first storage and retrieval system to the storage containers into the second storage and retrieval system, optionally, the at least one transfer system comprises a pick station or a picking station for receiving storage containers dropped off from the port column of the grid framework structure of the first automated storage and retrieval system. The pick station allows the contents of the storage container dropped off at the at least one port column to be accessed for picking from the outside of the grid framework structure. At the picking station, one or more items can be picked from the storage containers dropped off at the at least one port column of the grid framework structure of the first storage and retrieval system. The one or more picked items can then be collated and/or sorted for transfer to a differently sized storage container for subsequent storage in the grid framework structure of the second storage and retrieval system via its respective at least one port column. Whilst the particular embodiment describes the picking station being arranged to transfer the contents of the storage container dropped off at the least one port column of the first storage and retrieval system to a storage container being dropped off at least one port column of the second storage and retrieval system via the at least one transfer system, the present invention is not limited to transferring the contents of the storage containers and can include the transfer of the storage containers themselves from the pick station to a differently sized storage container for storage in grid framework structure of the second storage and retrieval system via the least one transfer system. Alternatively, one or more items can be placed in a separate delivery storage container and the delivery storage container can be placed inside a storage container for storage in the grid framework structure of the second storage and retrieval system. The delivery storage container make it convenient to keep the one or more items in the storage container together and provides easy transfer of the contents of the storage container to the differently sized storage container for storage in the grid framework structure of the second storage and retrieval system.

Optionally, the at least one port column of the grid structure of the second automated storage and retrieval system comprises an inlet port column for receiving one or more storage containers transferred from the at least one transfer system and an outlet port column for dropping off one or more storage containers to the least one transfer system. To transfer the contents of the storage container from the pick station to the storage container for subsequent storage in the grid structure of the second storage and retrieval system, the at least one transfer system comprises a buffer zone for holding one or more storage containers dropped off from the outlet port column of the first and/or second automated storage and retrieval systems. The differently sized storage containers are held at the buffer zone so that one or more items in one or more storage containers at the pick station can be transferred to the differently sized storage container in the buffer zone for subsequent transfer to the grid framework structure of the second storage and retrieval system. Alternatively, one or more storage containers can be transferred from the at least one port column of the first automated storage and retrieval system to a storage container held at the buffer zone of the second automated storage and retrieval system. Optionally, the buffer zone comprises a decant station configured for receiving one or more items picked from the pick station.

Optionally, the at least one transfer system comprises at least one conveyor system comprising at least one conveyor unit extending from the outlet port column of the grid framework structure of the first or second automated storage and retrieval system to the inlet port column of the grid framework structure of the first or second automated storage and retrieval system so as to transport one or more storage containers into and out of their respective grid framework structures.

Optionally, the at least one transfer system comprises a conveyor system comprising at least one conveyor unit extending from the at least one port column of the grid framework structure of the first automated storage and retrieval system to the at least one port column of the grid framework structure of the second automated storage and retrieval system so as to transport one or more storage containers from the first automated storage and retrieval system to the second automated storage and retrieval system.

Optionally, the at least one transfer system comprises at least one conveyor system comprising a first conveyor system arranged for transporting one or more storage container into and out of the grid framework structure of the first automated storage and retrieval system and a second conveyor system arranged for transporting one or more storage container into and out of the grid framework structure of the second automated storage and retrieval system. The first conveyor system being arranged to transport one or more storage containers from the outlet port column to the inlet port column via the transfer conveyor unit of the grid framework structure of the first automated storage and retrieval system. Equally, the second conveyor system being arranged to transport one or more storage containers from the outlet port column to the inlet port column via the transfer conveyor unit of the grid framework structure of the second automated storage and retrieval system.

To transport one or more storage containers into and out of the grid framework structures of the first automated storage and retrieval system or the second automated storage and retrieval system, optionally, the at least one conveyor system comprises an entry conveyor unit, an exit conveyor unit and a transfer conveyor unit, the exit conveyor unit being arranged to transport a storage container in a first direction from the outlet port column to the transfer conveyor unit and the entry conveyor unit being arranged to transport a storage container from the transfer conveyor unit in a second direction to the inlet port column.

The at least one conveyor system of the at least one transfer system transports storage containers from the outlet port to the inlet port via the buffer zone where the storage container is held at the buffer zone to accept storage containers or one or more items from the storage containers delivered from the first storage and retrieval system. Optionally, the transfer conveyor unit is arranged to transport a storage container from the exit conveyor unit to the entry conveyor unit. Optionally, the exit conveyor unit and the entry conveyor unit are arranged such that the first direction of the exit conveyor unit is opposite and parallel to the second direction of the entry conveyor unit and wherein the third direction of the transfer conveyor unit is substantially orthogonal to both the first direction of the exit conveyor unit and the second direction of the entry conveyor unit. Thus, a storage container exiting the grid framework structure of the second storage and retrieval system via the outlet port travels in a substantially “U” shaped path to the inlet port of the grid structure.

Transfer of the one or more items from the pick station to the storage container at the buffer zone of the second automated storage and retrieval system can be done by a manual operation or by an automatic operation. Optionally, the pick station comprises a robotic arm for transferring one or more items from one or more storage containers of the first automated storage and retrieval system dropped off at the pick station to one or more storage containers at the buffer zone, preferably, at the transfer conveyor unit of the second automated storage and retrieval system. To assist with the picking of one or more items from the pick station, preferably the pick station comprises a tilting mechanism for tilting the storage container and a slide adjacent the tilting mechanism for capturing one or more items exiting the tilting mechanism.

Optionally, the storage containers of the first automated storage and retrieval system comprise shallow trays mounted on spacing means to vertically space the shallow trays from one another in the stacks in the grid framework structure of the first automated storage and retrieval system. Each of the shallow trays comprises a bottom wall and an upwardly extending rim comprising one or more cutouts, through which one or more items inside the shallow tray can be accessed when the shallow trays are stored in stacks in the grid framework structure of the first automated storage and retrieval system.

Preferably, each load handling device of the plurality of load handling devices of the first and the second automated storage and retrieval systems comprises a lifting mechanism comprising a grabber device configured to releasably engage with a storage container and a winch mechanism configured to lift the storage container above the track system. The lifting mechanism may be arranged inside the vehicle body and comprises a lifting frame, otherwise known as a grabber device, which is adapted to releasable engage with a storage container and a winch mechanism comprising lifting tethers wound on at least one spool and a winch motor configured to lift the storage container from a stack above the track system. The grabber device can be lowered from the vehicle body so that the position of the grabber device is able to mount the top or rim of the storage container. The grabber device comprises gripper elements which are configured to grip the rim of the storage container so that when the winch motor is powered, the storage container is lifted into the container receiving space of the robotic load handling device.

To enable automated and secure routing of items received at the automated load handling system of the present invention, preferably, the automated load handling system further comprises a control system comprising one or more processors and memory storing instructions that when executed by the one or more processors is configured:
a) to receive a request for storage of an item associated with a user or at least a portion of a product,
b) to generate a unique identification comprising data associated with the user or the at least a portion of a product,
c) to assign the unique identification to a storage container in the first automated storage and retrieval system;
d) to store data associated with the unique identification in a database.

Data associated with a user includes but is not limited to the name of the user, and/or place of residence and/or other attributed associated with the user, e.g. place of employment. Alternatively, the unique identification can comprise data associated with at least a portion of a product. Optionally, the automated load handling system of the present invention can form part of an assembly line where one or more items retrieved from one or more storage containers from the first automated storage and retrieval system can be assembled together to form at least a portion of a product or an entire product prior to being transferred for storage in the grid framework structure of the second automated storage and retrieval system. Optionally, the at least one transfer system comprises at least one assembly station for assembling one or more items from one or more storage containers from the first automated storage and retrieval system.

Preferably, the unique identification is assigned to a storage container in the first automated storage and retrieval system by correlating a grid location of the storage container in the grid framework structure of the first automated storage and retrieval system to the unique identification. One way to assign a unique identification associated with a user to a storage container in the first automated storage and retrieval system is by correlating the position of the storage container in the grid framework structure of the first automated storage and retrieval system to the unique identification. For the purpose of the present invention, the track system guides the movement of the robotic load handling devices in an X and Y direction in a horizontal plane and the lifting mechanism is configured to move the grabber device in a third Z direction to access the storage container in a stack. For the purpose of the present application, Z=1 defines the uppermost layer of the grid framework structure, i.e. the layer immediately below the track system, Z=2 is the second layer below the track system, Z=3 is the third layer below the track system and so on. The position of each of the storage containers held in the grid framework structure of the first and the second storage and retrieval systems can be represented by a Cartesian coordinate system, X, Y, Z. For example, for a storage container can be said to position in a grid location determined from the Cartesian coordinate system, X, Y, Z.

As well as the storage containers in the grid framework structure of the first storage and retrieval system being assigned a unique identification associated with a respective user, the control system is further configured:
a) to generate a unique identification comprising data associated with each storage container in the second automated storage and retrieval system;
b) to assign the unique identification of the storage container to the position of the storage container in the grid framework structure of the second automated storage and retrieval system.

In addition to generating a unique identification associated with a user and assigning the unique identification to a grid location (X, Y, Z) of the first automated storage and retrieval system, the control system further generates a unique identification comprising data associated with each storage container in the grid framework structure of the second automated storage and retrieval system and assigning the unique identification of the storage container to a grid location of the storage container in the grid framework structure of the second automated storage and retrieval system. In this way, the control system is able to correctly identify the item or storage container from the grid framework structure of the first storage and retrieval system to be transferred to the correct storage container in the grid framework structure of the second storage and retrieval system. Preferably, the control system is configured to consolidate or collate a plurality of items from one or more storage containers in the first storage and retrieval system for transfer to a storage container in the grid framework structure of the second automated storage and retrieval system based on their respective unique identification. One or more items or even one or more storage containers can be collated or consolidated together for transfer to a storage container in the grid framework structure of the second automated storage and retrieval system based on their respective unique identification. Preferably, the control system is configured to consolidate or collate a plurality of items from one or more storage containers in the first storage and retrieval system by consolidating their respective unique identification associated with one or more users or at least a portion of a product. For example, where the one or more items are baggage associated with one or more users where each baggage has been assigned a unique identification comprising data associated with a user, then the control system is configured to consolidate or collate the baggage in storage in the first storage and retrieval system based on first identifying their respective unique identification and once identified, consolidating their respective unique identification. In the case of an assembly line, the one or more items can be consolidated or collated together for assembly into at least a portion of a product at the assembly station prior to being transferred to a storage container in the grid framework structure of the second automated storage and retrieval system.

Preferably, the control system is configured to assign the consolidated respective unique identification associated with one or more users or at least portion of a product to a unique identification of the storage container of the second automated storage and retrieval system. Thus, a storage container in the grid structure of the second automated storage and retrieval system has been prepared for accommodating the consolidated items from the one or more storage containers in the first automated storage and retrieval system. The unique identification of the storage containers of the second automated storage and retrieval system can correspond to the consolidated unique identification of the storage containers from the first automated storage and retrieval system based on data associated with the user, or another attribute common to one or more users, or an attribute associated with at least a portion of a product. For example, in the case where the automated load handling system is an automated baggage handling system, the attribute could be data associated with travel details that are common to one or more users, e.g. flight number. Thus, the unique identification of the storage containers from the first and second automated storage and retrieval systems can correspond to data associated with flight details. Equally, where the one or more items in the storage containers form part of at least a portion of a product, the unique identification of one or more storage containers of the second automated storage and retrieval system can correspond to the consolidated unique identification of the storage containers from the first automated storage and retrieval system based on data associated with the at least portion of the product.

Preferably, the control system is further configured to instruct one or more load handling devices operative on the track system of the first automated storage and retrieval system to retrieve one or more storage containers to its respective port column based on a corresponding unique identification of the storage container of the second automated storage and retrieval system being at the at least one transfer system by:
i) correlating the unique identification associated with one or more users to the corresponding unique identification of the storage container of the second automated storage and retrieval system at the at least one transfer system;
ii) identifying the one or more storage containers in the grid framework structure of the first automated storage and retrieval system based on correlating the unique identification to the grid location of the storage container in its respective grid framework structure of the first automated storage and retrieval system;
iii) instructing a load handling device operative on the track system of the first automated storage and retrieval system to retrieve the one or more storage containers from its grid location and move the one or more storage containers to the at least one port column of the first automated storage and retrieval system.

Depending on the unique identification of the storage container of the second automated storage and retrieval system at the at least one transfer system (i.e. the buffer zone), the control system is configured to correlate the unique identification associated with one or more users from the first automated storage and retrieval system to a corresponding unique identification of the storage container at the at least one transfer system. The storage container at the at least one transfer system is differently sized so as to accommodate one or more items from the storage containers or the storage containers themselves from the first automated storage and retrieval system. For example, the storage containers from the second automated storage and retrieval system can be a unit load device (ULD) commonly used to load luggage or freight on to an aircraft at airports. Correlation of the unique identification of one or more storage containers from the first automated storage and retrieval system to the unique identification of the storage container from the second automated storage and retrieval system at the at least one transfer system can be, for example, based on flight data. In the case of a baggage handling system, the unique identifications of the first and second automated storage and retrieval system can additionally comprise data associated with a user specified destination, together with booking data indicating a flight onto which the user is booked.

Once the control system has correlated the storage containers associated with the unique identifications of the storage containers from the first and second automated storage and retrieval systems, the control system then identifies the one or more storage containers from the first automated storage and retrieval system to fulfil the packing of the storage containers from the first automated storage and retrieval system into the storage container from the second automated storage and retrieval system at the at least one transfer system. The control system locates the one or more storage containers in the grid framework structure of the first automated storage and retrieval system based on correlating the unique identification to the grid location of the storage container in its respective grid framework structure of the first automated storage and retrieval system. The control system then instructs one or more load handling devices operative on the track system of the first automated storage and retrieval system to retrieve the one or more storage containers from its position and move the one or more storage containers to the at least one port column of the first automated storage and retrieval system. At the at least one port column, the at least one transfer system is configured to transfer one or more storage containers or one or more items from the storage containers from the at least one port column of the first automated storage and retrieval system to one or more storage containers from the at least one port column of the second automated storage and retrieval system.

The automated handling system of the present invention can be utilised as a baggage handling system at an airport, in which case the automated handling system is an automated baggage handling system such that each of the one or more items stored in the one or more storage containers in the first automated storage and retrieval system is a baggage item. The unique identification associated with the user is baggage tag data, said baggage tag data comprising data associated with a user specified destination, together with booking data indicating travel data. In this case, each of the one or more storage containers in the second automated storage and retrieval system is a unit load device (ULD). The automated handling system is not limited to a baggage handling system but can be used for any automated handling system. For example, the automated handling system can be used for the collation and storage of items associated with one or more users in a house move. Equally, the term “user” can be broadly construed to cover a legal entity such as a company or cooperation.

In the case where at least a portion of the product comprises an assembly of the consolidated or collated plurality of items, preferably, the control system is further configured to instruct one or more load handling devices operative on the track system of the first automated storage and retrieval system to retrieve one or more storage containers based on a unique identification associated with at least a portion of the product by:
i) identifying one or more storage containers comprising one or more items, each of the one or more items forming part of the at least portion of the product;
ii) locating the one or more storage containers in the grid framework structure of the first automated storage and retrieval system based on correlating the unique identification to the grid location of the storage container in its respective grid framework structure of the first automated storage and retrieval system;
iii) instructing one or more load handling devices operative on the track system of the first automated storage and retrieval system to retrieve the one or more storage containers from their grid location and move the one or more storage containers to the at least one port column of the first automated storage and retrieval system, each of the one or more storage containers comprising one or more items for assembly into at least a portion of the product.

When assembling at least a portion of a product or a complete product, the control system identifies the items or parts that are needed to assemble the at least portion of the product. Once identified, the control system locates the storage containers for their respective grid locations in the first automated storage and retrieval system and instructs one or more load handling devices operative on the track system to retrieve the one or more storage containers and move the one or more storage containers to the at least one port column of the first automated storage and retrieval system. The one or more items can then be assembled together at the assembly station prior to being transferred via the at least one transfer system to a storage container at the second automated storage and retrieval system.

The present invention further provides a method of handling one or more items in an automated load handling system in response to one or more storage containers from the second automated storage and retrieval system being at the at least one transfer system comprising the steps of:
i) identifying one or more storage containers comprising one or more items by correlating the unique identification associated with one or more users from the first automated storage and retrieval system to the unique identification of the one or more storage containers from the second automated storage and retrieval system at the at least one transfer system;
ii) instructing one or more load handing devices operative on the track system of the first automated storage and retrieval system to retrieve the one or more identified storage containers and move the one or more storage containers to the at least one port of the grid framework structure of the first storage and retrieval system;
iii) transferring one or more items from the identified one or more storage containers to the one or more storage containers from the second automated storage and retrieval system at the at least one transfer system;
iv) instructing one or more load handing devices operative on the track system of the second automated storage and retrieval system to move the one or more storage containers from the at least one transfer system to a storage column of the grid framework structure of the second automated storage and retrieval system.

In preparation for transferring one or more items or storage containers from the first automated storage and retrieval system to one or more storage containers of the second automated storage and retrieval system, the method further comprises the step of instructing one or more load handing devices operative on the track system of the second automated storage and retrieval system to retrieve one or more storage containers from the grid framework structure of the second automated storage and retrieval system to the at least one transfer system based on the unique identification of the one or more consolidated storage containers from the first automated storage and retrieval system.

The present invention further provides a method of assembling one or more items from an automated load handling system according to the present invention to form at least a portion of product comprising the steps of:
i) identifying one or more storage containers comprising one or more items having a unique identification associated with the at least portion of the product from the first automated storage and retrieval system;
ii) instructing one or more load handling devices operative on the track system of the first automated storage and retrieval system to retrieve the one or more storage containers from its grid location and move the one or more storage containers to the at least one port column of the first automated storage and retrieval system, each of the one or more storage containers comprising one or more items for assembly into the at least a portion of the product;
iii) assembling the one or more items from the one or more storage containers to form the at least a portion of the product;
iv) transferring the at least a portion of the product to one or more storage containers from the second automated storage and retrieval system at the at least one transfer system;
v) instructing one or more load handing devices operative on the track system of the second automated storage and retrieval system to move the one or more storage containers from the at least one transfer system to a storage column of the grid framework structure of the second automated storage and retrieval system.

### BRIEF DESCRIPTION OF THE DRAWINGS

The automated handling system will now be described in detail with reference to examples, in which:

FIG. 1 schematically illustrates an automated handling system with first and second automated storage and retrieval systems;

FIG. 2 schematically illustrates a grid framework structure and containers;

FIG. 3 schematically illustrates track on top of the grid framework structure illustrated in FIG. 1;

FIG. 4 schematically illustrates load-handling devices on top of the grid framework structure illustrated in FIG. 2:

FIG. 5 schematically illustrates a single load-handling device with container-lifting means in a lowered configuration;

FIG. 6 schematically illustrates cutaway views of a single load-handling device with container-lifting means in a raised and a lowered configuration:

FIG. 7 schematically illustrates a first automated storage and retrieval system comprising a grid framework structure and storage containers and load handling devices;

FIG. 8 schematically illustrates a second automated storage and retrieval system comprising a grid framework structure and storage containers and load handling devices:

FIG. 9 schematically illustrates an automated handling system with first and second automated storage and retrieval systems:

FIG. 10 schematically illustrates a different view of the automated handling system with first and second automated storage and retrieval systems:

FIG. 11(a) schematically illustrates a pick station.

FIG. 11(b) is a perspective view of a storage container of FIG. 7;

FIG. 12 schematically illustrates a view of the automated handling system with first and second automated storage and retrieval systems:

FIG. 13 schematically illustrates a view of the automated handling system with first and second automated storage and retrieval systems:

FIG. 14 schematically illustrates a view of the automated handling system with first and second automated storage and retrieval systems:

FIG. 15 is a block diagram showing the components of the automated handling system according to an exemplary embodiment of the present invention:

FIG. 16 is a flowchart illustrating the process of allocating a unique identification to a storage container in a grid framework structure:

FIG. 17 is a flowchart illustrating an exemplary embodiment of the sortation of the storage containers in the automated handling system.

FIG. 18 is a flowchart illustrating an application of an automated handling system as an assembly system:

FIG. 19 illustrates an exemplary embodiment of an assembly station;

FIG. 20 illustrates an automated assembly system incorporating the assembly station of FIG. 19:

FIG. 21 illustrates the pick station of FIG. 11 adjacent to the second automated storage and retrieval system:

FIG. 22 illustrates pick stations adjacent to the second automated storage and retrieval system:

FIG. 23 is a schematic view of an automated handling system with first and second automated storage and retrieval systems and transfer systems:

FIG. 24 is a schematic view of the back of the automated handling system illustrating storage containers being loaded onto cargo dollies:

FIG. 25 is a schematic plan view of an automated handling system.

### DETAILED DESCRIPTION

The automated handling system comprises two or more automated storage and retrieval systems. Each of the two or more automated storage and retrieval systems comprises a grid framework structure and one or more load handling devices, as will be described in more detail below. The storage containers of the automated storage and retrieval systems are differently sized, and storage containers or items within storage containers are collated and/or sorted as they are transferred from one automated storage and retrieval system to another.

The invention is described below with reference to a first automated storage and retrieval system and a second automated storage and retrieval system, where the grid openings and the storage containers and load handling devices of the second automated storage and retrieval system are larger than the grid openings and storage containers and load handling devices of the first automated storage and retrieval system.

The terms “large grid openings” will be used to describe the grid openings of the second automated storage and retrieval system, and the term “small grid openings” will be used to describe the grid openings of the first automated storage and retrieval system. The terms “large containers” or “large storage containers” will be used to describe the storage containers of the second automated storage and retrieval system, and the term “small containers” or “small storage containers” will be used to describe the storage containers of the first automated storage and retrieval system. The terms “large load handling devices” will be used to describe the load handling devices of the second automated storage and retrieval system, and the term “small load handling devices” will be used to describe the load handling devices of the first automated storage and retrieval system. It will be appreciated that the automated handling system with two automated storage and retrieval systems, as described below, is one example of the claimed invention, and the invention also encompasses automated handling systems that comprise more than two automated storage and retrieval systems, and with more than two sizes of grid openings and storage containers and load handling devices.

The large storage containers of the second automated storage and retrieval system may be sized such that several of the small storage containers of the first automated storage and retrieval system can be accommodated inside the large containers of the second automated storage and retrieval system. For example, the dimensions of the large storage containers may be chosen to be an integer multiple of the dimensions of the small storage containers, plus some allowance for clearance. For example, the length and breadth and height of the large storage containers may be twice the length and breadth and height respectively of the small storage containers, such that eight of the small storage containers can be accommodated inside one large storage container.

As an alternative to placing the small storage containers inside the larger containers, one or more items may be picked out of the small containers and into the large storage containers. In some applications the storage containers can be trays rather than deep-sided containers, to facilitate the removal of the items from the containers or the placing of items in the containers. The automated handling system comprises one or more transfer systems, to transfer storage containers or items within storage containers from one automated storage and retrieval system to another. For the purposes of this description, the example will be given of storage containers from the first automated storage and retrieval system being transferred to the second automated storage and retrieval system.

### Example Applications

There are many possible applications for the automated handling system. For example, the automated handling system may be an automated baggage handling system for handling baggage for passenger transport. For example, the storage containers in one of the automated storage and retrieval systems may be shipping containers, and the automated handling system may be for preparing goods for shipping in shipping containers. The storage containers may be for storing personal belongings and furniture for customers moving house or placing belongings in long-term or short-term storage facilities. The automated handling system may be for fulfilling orders for vehicles for showrooms or retailers or fleet customers, and the storage containers may contain vehicles. The automated handling system may be for fulfilling customer orders (for example, grocery orders) and collating the orders into larger shipments to be sent to the spokes of a hub-and-spoke distribution network. The automated handling system may be for prefabricated or modular buildings. The automated handling system may be an automated assembly line, in which parts from the first automated storage and retrieval system are assembled, and the assembled product transferred for storage in the second automated storage and retrieval system. These applications are non-limiting examples only, and the automated handling system may be used for handling any kinds of goods or products or items for retail or distribution or any other application.

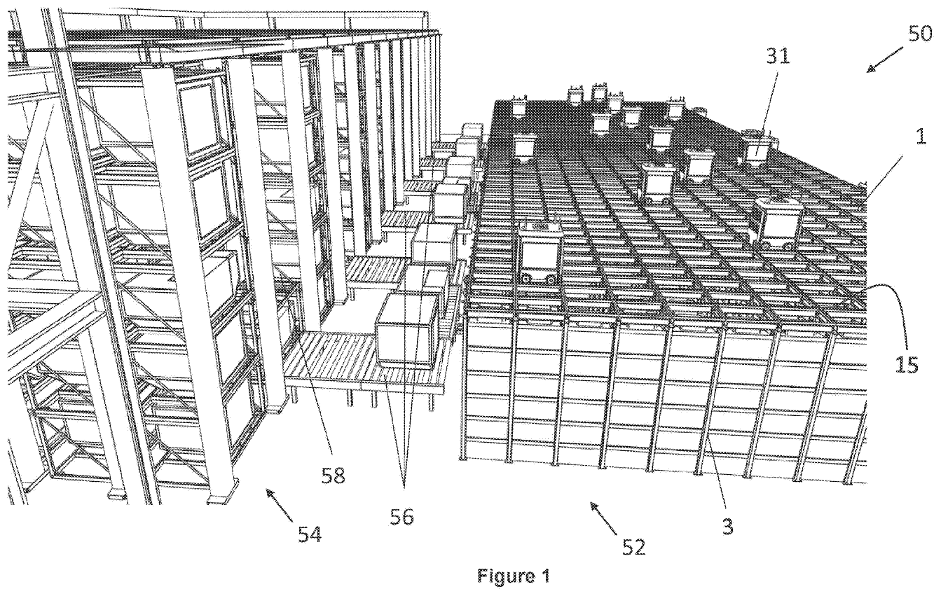

FIG. 1 schematically illustrates an automated handling system 50 with a first automated storage and retrieval system 52 and a second automated storage and retrieval system 54. It can be seen clearly from FIG. 1 that the grid framework structures 1 of the two automated storage and retrieval systems are of different sizes: the storage columns 10, the storage containers 9, the spacing between the upright members 3, the grid openings or apertures 15, and the load handling devices 31, are all proportionally larger in the second automated storage and retrieval system than in the first automated storage and retrieval system. In the particular embodiment shown in FIG. 1, the first automated storage and retrieval system 52 is configured to store small storage containers 9 and the second automated storage and retrieval system 54 is configured to store large storage containers 9

FIG. 1 also illustrates transfer systems 56 positioned between the first automated storage and retrieval system 52 and the second automated storage and retrieval system 54. The transfer systems are used to transfer storage containers, or items within storage containers, from one automated storage and retrieval system to another automated storage and retrieval system. The transfer system may comprise a conveyor system, comprising one or more conveyor units, extending between the first and the second automated storage and retrieval systems. One or more port columns 58 in the second automated storage and retrieval system 54 are used to transport large storage containers 9 into and out of the grid framework structure 1 of the second automated storage and retrieval system 54 to one of the transfer systems 56. The one or more port columns 58 can be defined as an outlet port column configured for dropping off one or more storage containers into the transfer system, and an inlet port column configured for picking up one or more storage containers from the transfer system. In a similar manner, one or more port columns 58 (not shown) in the first automated storage and retrieval system 52 are used to transport small storage containers 9) into and out of the grid framework structure 1 of the first automated storage and retrieval system 52 to the same transfer system 56. Items can then be transferred between the large and small storage containers, or small storage containers 9 can be placed into or removed from the large storage containers 9.

### Automated Storage and Retrieval System

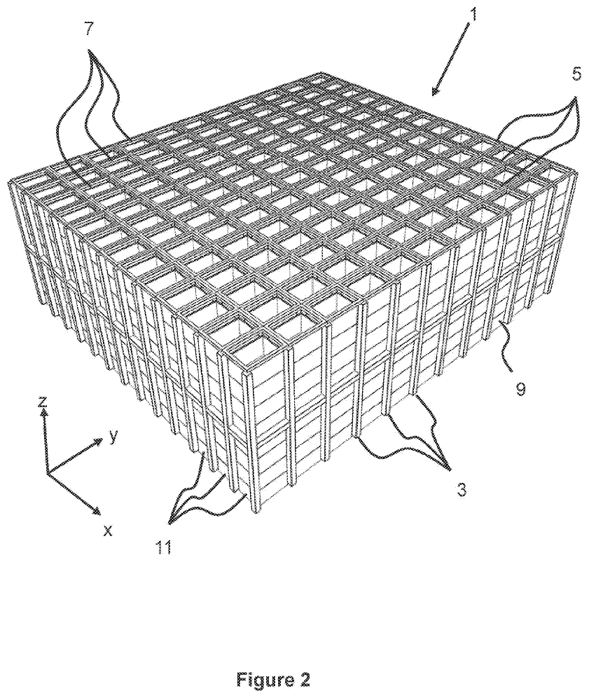

A preferred embodiment of an automated storage and retrieval system will be described below, with reference to FIGS. 2-6.

FIG. 2 illustrates a grid framework structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid spaces or grid cells 14, each of the grid spaces or grid cells 14 defining a grid opening 15. In the illustrated example, containers 9 are arranged in stacks 11 beneath the grid cells 14 defined by the grid pattern, one stack 11 of containers 9 per grid cell 14. The grid openings 15 provide the spaces for the storage container 9 to exit the grid framework structure.

In the illustrated example, the stacks 11 of containers 9 occupy storage columns 10, where each storage column 10 is beneath one grid cell 14. A storage column can be defined as the space between four upright members 3, with one upright member 3 at each corner of the storage column.

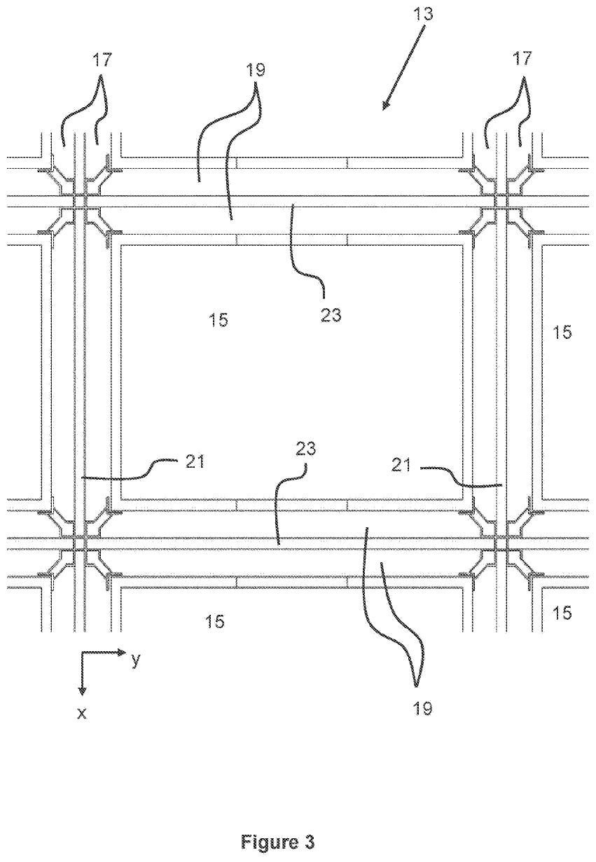

FIG. 3 shows a large-scale plan view of a section of track system 13 forming part of the grid framework structure 1 illustrated in FIG. 2 and located on top of the horizontal members 5, 7 of the grid framework structure 1 illustrated in FIG. 2. The track system 13 may be provided by the horizontal members 5, 7 themselves (e.g. formed in or on the surfaces of the horizontal members 5, 7) or by one or more additional components mounted on top of the horizontal members 5, 7. For example, the horizontal members 5, 7 may comprise rails or tracks, or rails or tracks may be mounted on top of the horizontal members. The illustrated track structure 13 comprises x-direction rails or tracks 17 and y-direction rails or tracks 19, i.e. a first set of tracks 17 which extend in the x-direction and a second set of tracks 19 which extend in the y-direction, transverse to the tracks 17 in the first set of tracks 17. The tracks 17, 19 define grid openings 15 at the centres of the grid cells 14. The grid openings 15 are sized to allow containers 9 located beneath the grid cells 14 to be lifted and lowered through the grid openings 15. The x-direction tracks 17 are provided in pairs separated by channels 21, and the y-direction tracks 19 are provided in pairs separated by channels 23. Other arrangements of track structure may also be possible.

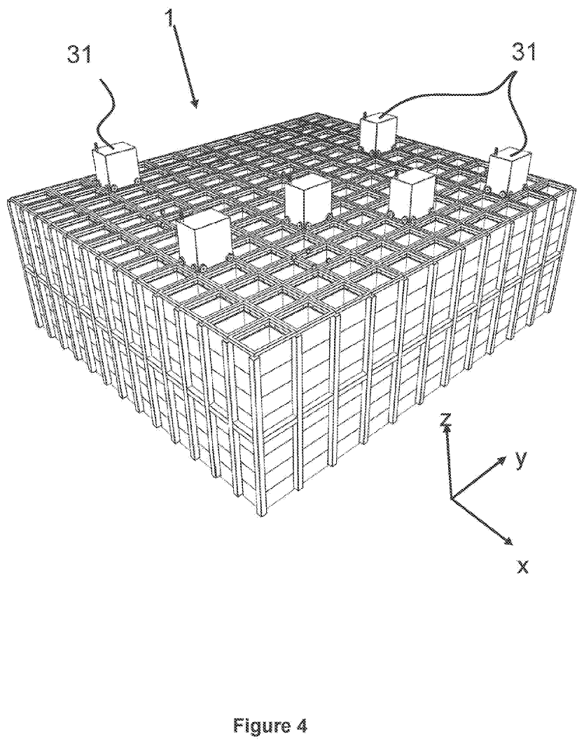

FIG. 4 shows a plurality of load-handling devices 31 moving on top of the storage structure 1 illustrated in FIG. 2. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

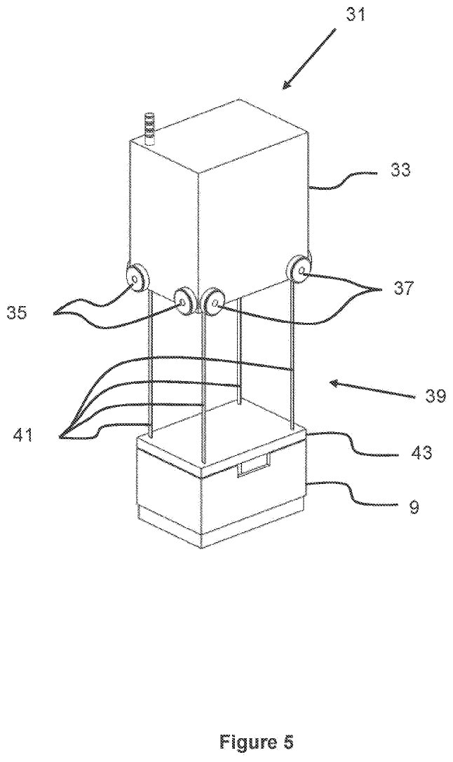

As illustrated in detail in FIG. 5, a bot 31 comprises a body 33 in or on which are mounted one or more components which enable the bot 31 to perform its intended functions. These functions may include moving across the grid framework structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 5, and a further two wheels 35 are provided on the opposite shorter side of the bot 31 (side and further two wheels 35 not visible in FIG. 5). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 5, and a further two wheels 37 are provided on the opposite longer side of the bot 31 (side and further two wheels 37 not visible in FIG. 5). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. A winch mechanism 40, which could be one or more motors or other means, may be provided to effect or control the winding up or down of the tapes 41.

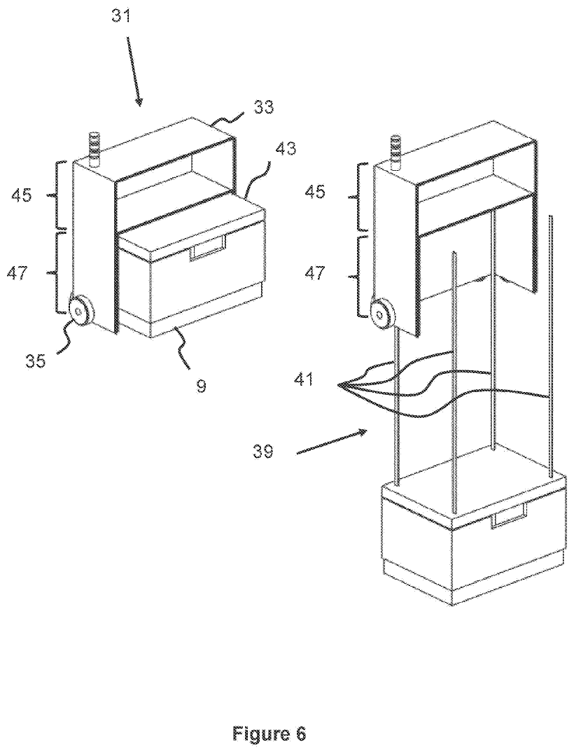

As can be seen in FIG. 6, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9) that has been raised by the container-lifting means 39. The container-receiving space is sized such that enough of a container 9 can fit inside the cavity to enable the bot 31 to move across the track structure 13 on top of grid framework structure 1 without the underside of the container 9 catching on the track structure 13 or another part of the grid framework structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the grid framework structure 1 (or an ingress point of the grid framework structure 1 if the bot 31 has moved to collect a container 9 for storage in the grid framework structure 1). Port columns are an example of ingress and egress points. Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g, in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

### Automated Storage and Retrieval Systems of Different Sizes

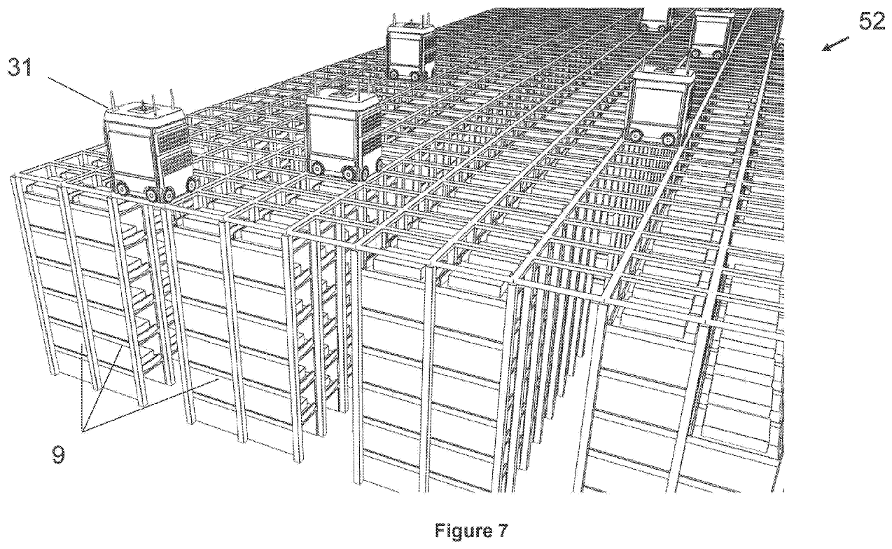

FIG. 7 schematically illustrates an embodiment of a first automated storage and retrieval system 52. The first automated storage and retrieval system 52 comprises a grid framework structure 1 and load handling devices 31. As described in more detail above, the load handling devices 31 operate on top of the grid framework structure 1, and traverse the track system 13 by means of two sets of wheels 35, 37 which engage with the x-direction tracks 17 and the y-direction tracks 19 respectively. The load handling devices 31 are configured to retrieve and replace containers 9 from the stacks 11 of containers in the storage columns 10, through the grid openings 15.

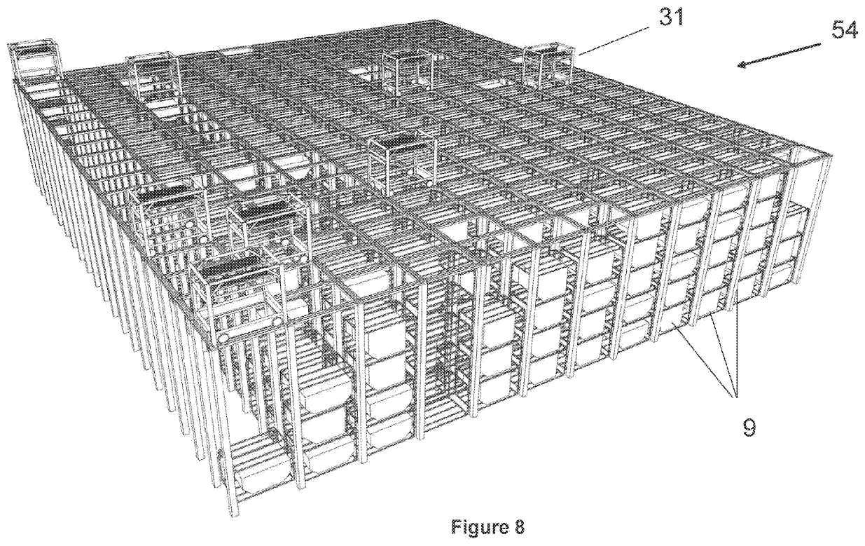

FIG. 8 schematically illustrates a second automated storage and retrieval system 54. The second automated storage and retrieval system comprises a grid framework structure 1 and load handling devices 31, and operates in a similar manner to the first automated storage and retrieval system.

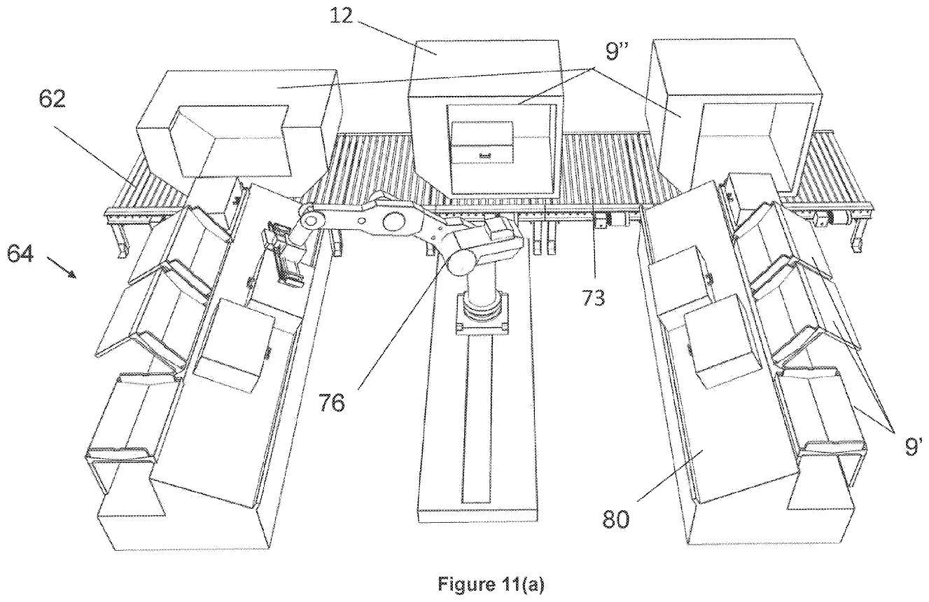

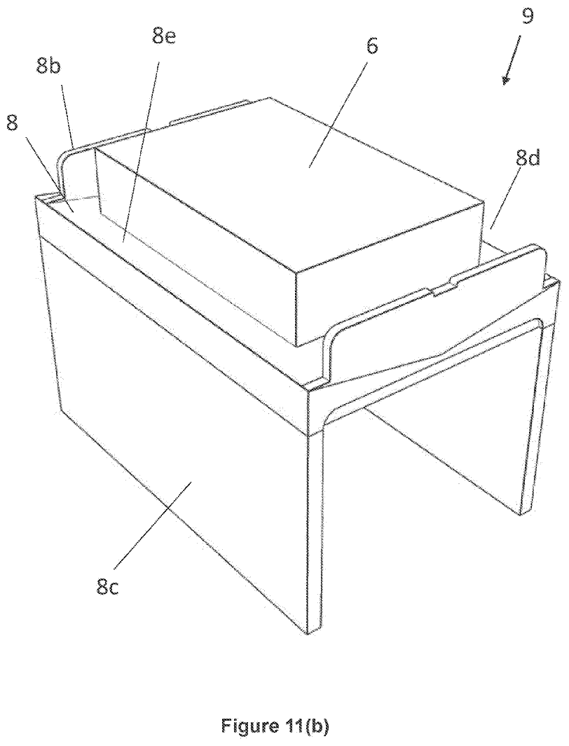

In the automated second storage and retrieval system 54 illustrated in FIG. 8, the storage containers 9) are accommodated inside cages 12 (see FIG. 11(a)). As an alternative to the container-engaging assembly 43 engaging directly with features of the storage containers 9, as described above in relation to FIG. 5, the container-engaging assembly 43 may engage with features of the cages 12. For instance, the cages 12 may be provided with one or more apertures in their upper sides with which the engaging means can engage. Alternatively or additionally, the engaging means may be configured to hook under bars of the cages 12 and/or to clamp or grasp the cage 12.

The storage containers 9 of the first automated storage and retrieval system 52 as illustrated in FIG. 7 are trays rather than deep-sided containers, to facilitate the removal of items from the containers or the placing of items in the containers. This alternative embodiment of the storage containers 9 can be advantageous in some applications, for example in applications where individual items are transferred from the small storage containers of the first automated storage and retrieval system 52 to or from the large storage containers of the second automated storage and retrieval system 54.

### Transfer System

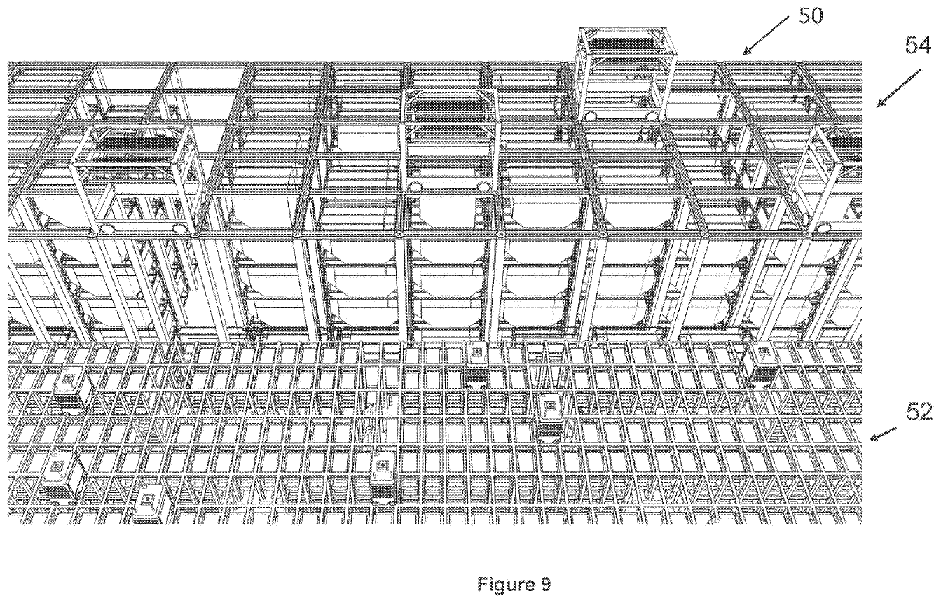

FIG. 9 schematically illustrates an embodiment of an automated handling system 50 with first and second storage and retrieval systems 52, 54 as illustrated in FIGS. 7 and 8 respectively. It can be seen from FIG. 9) that the two grid framework structures 1 of the first and second automated storage and retrieval systems 52, 54 are of different sizes and scales. The storage containers 9, the load handling devices 31, and the grid apertures 15 of the second automated storage and retrieval system 54 are all larger in terms of height and/or length and/or width than the respective storage containers 9, the load handling devices 31, and the grid apertures 15 of the first automated storage and retrieval system 52. The larger storage containers 9 of the second automated storage and retrieval system 54 have a greater volume capacity than the storage container of the first automated storage and retrieval system 52.

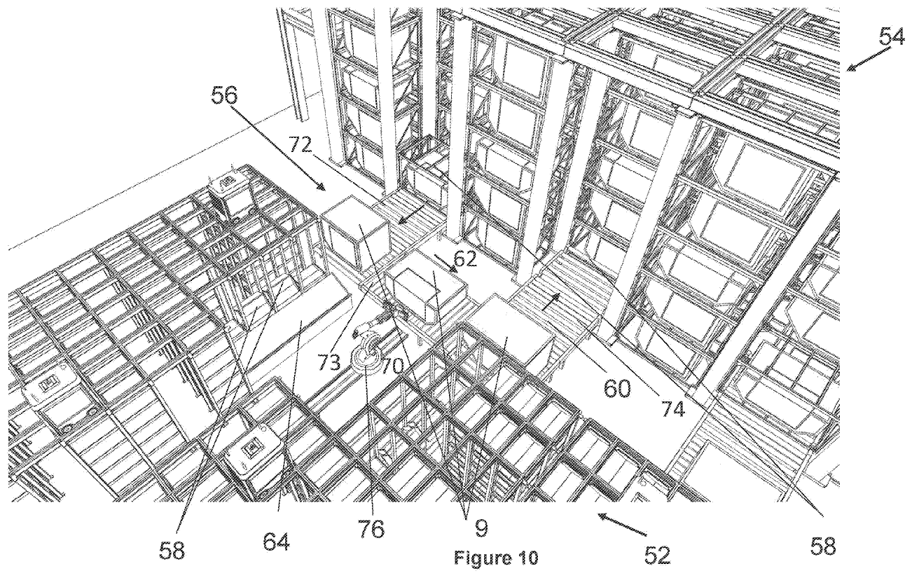

FIG. 10 schematically illustrates a different view of the automated handling system 50, with first and second storage and retrieval systems 52, 54, and transfer systems 56. Storage containers 9 from the second automated storage and retrieval system 54 can be seen at the transfer system 56. The large storage containers 9 are transported into and out of the grid framework structure 1 of the second automated storage and retrieval system 54 via one or more port columns 58. In the illustrated embodiment, the transfer system 56 transports the large storage containers 9 of the second automated storage and retrieval system 54 to a position adjacent to one or more pick stations 64 of the first automated storage and retrieval system 52, where one or more items or storage containers picked from the first automated storage and retrieval system are transferred to one or more storage containers from the second automated storage and retrieval system. The transfer system 56 comprises at least one conveyor system 60. In the illustrated embodiment, the at least one conveyor system comprises three conveyor units 62 extending in and out of the port columns of the grid framework structure of the second automated storage and retrieval system.

The first automated storage and retrieval system 52 is provided with one or more port columns 58 to transfer the small storage containers 9 to a position adjacent to the one or more pick stations 64. At the pick station 64, items are transferred between the small storage containers 9 of the first automated storage and retrieval system 52 and the large storage containers 9 of the second automated storage and retrieval system 54. Items can be transferred from the small storage containers into the large storage containers, or from the large storage containers into the small storage containers. In the illustrated embodiment, the pick station 64 is provided with one or more robotic arms 76, which are configured to pick up items from the small storage containers 9 and place them into the large storage containers 9 on the conveyor system 60. The transfer system 56 further comprises a decant station configured to receive the items picked from one or more storage containers at the pick station 64. Thus, items picked from a storage container at the pick station from the first automated storage and retrieval system is transferred to a storage container at the decant station for storage in the second automated storage and retrieval system.

### Conveyor Systems

As described above in the embodiment of the transfer system 56 illustrated in FIG. 10, the at least one conveyor system 60 comprises three conveyor units 62. The three conveyor unites are termed the exit conveyor unit 72, entry conveyor unit 74, and transfer conveyor unit 73.

The conveyor system 60 transports the storage bin or container 9 from a port column of the second automated storage and retrieval system 54 to a picking station 64 delivered from the first automated storage and retrieval system 52, and then back to a port column of the second automated storage and retrieval system. In one embodiment, the storage bin or container may be vertically accumulated to be picked up by a load handling device 31 operative on the grid framework structure 1 and either returned to its original destination in the grid framework structure 1 or a new destination in the grid framework structure 1. In one embodiment of the present invention, the at least one conveyor system 60 of the transfer system 56 comprises multiple conveyor units 62, namely the entry conveyor unit 74, at least one transfer conveyor unit 73, and the exit conveyor unit 72 as discussed above, and arranged to transport the storage bin or container 9) from a port column of an automated storage and retrieval system to a buffer zone 70. The storage bin or container 9 is paused at the buffer zone 70. The pick station 64 and/or the decant station is located at the buffer zone such that a storage container at the buffer zone 70 can be accessed from the pick station 64 and/or decant station. The multiple conveyor units 62 are arranged adjacent to each other or connected to each other such that a storage container 9 is transported from one conveyor unit to an adjacent conveyor unit as it travels along the conveyor system 60. In the embodiment of the at least one conveyor system illustrated in FIG. 10, the buffer zone 70 is the transfer conveyor unit 73. In other embodiments there may be provided a buffer zone 70 which is separate from and adjacent to the at least one conveyor system 60.

The entry conveyor unit 74, the transfer conveyor unit 73, and the exit conveyor unit 72 are on the same level. Each conveyor unit 62 may comprise any suitable arrangement of belt(s), chain(s) and/or rollers well known in the art of conveyor systems. In one embodiment, the entry conveyor unit 74, the transfer conveyor unit 73, and the exit conveyor unit 72 comprise a plurality of roller conveyors for transporting storage bins or containers along a path on the conveyor system 60. The entry conveyor unit 74, the transfer conveyor unit 73, and the exit conveyor unit 72 are arranged such that the path of the transport direction of the storage bins or containers (shown by the arrows in FIG. 10) can follow a U-shaped path or an L-shaped path. The conveyor system 60 may be mounted on a roller frame. The entry conveyor unit 74 and the exit conveyor unit 72 are arranged to accommodate a single storage container 9 on top.

The path or transport direction of the entry conveyor unit 74 may be parallel and opposite to the path or transport direction of the exit conveyor unit 72 such that the path or transport direction of the at least one transfer conveyor unit 73 is perpendicular or orthogonal to the path or transport direction of both the entry conveyor unit 74 and the exit conveyor unit 72. In other words, the storage bin or container 9 travels in a U-shaped path along the conveyor system 60, where the storage container 9 exits the automated storage and retrieval system and returns back into the automated storage and retrieval system via the at least one transfer conveyor unit 73, i.e. the storage container 9) changes direction twice along the conveyor system 60. Optionally, the path or transport direction of the entry conveyor unit 74 extends longitudinally in the same transport direction of the transfer conveyor unit 73, i.e. the entry conveyor unit 74 is an extension of the transfer conveyor unit 73. Here, the path or transport direction of the entry conveyor unit 74 is perpendicular or orthogonal to the path or transport direction of both the transfer conveyor unit 73 and the exit conveyor unit 72 such that the storage bin or container 9 travels in an L-shaped path along the conveyor system 60, i.e. the storage bin or container 9) changes direction once as it travels from the port column to the buffer zone. In one embodiment, the conveyor system is arranged such that the path or transport direction of the storage bin can follow both a U-shaped path and an L-shaped path along the conveyor system. The combination of the U-shaped path and the L-shaped path permits multiple storage bins or containers 9 to be queued at the buffer zone 70 before being lifted towards the grid framework structure 1 for subsequent retrieval by a load handling device 31 operative on the track system 13 on the grid framework structure 1. This allows multiple storage bins or containers 9 to be processed through the transfer system 56. The combination of the U-shaped path and the L-shaped path allows for a relatively small width of the transfer system 56 for processing multiple storage bins or containers 9 at the buffer zone.

The transfer conveyor unit 73 extends between the entry conveyor unit 74 and the exit conveyor unit 72 and can comprise multiple conveyor units 62 arranged adjacent each other in the horizontal plane such that a storage bin or container 9 is transported from one conveyor unit 62 to an adjacent conveyor unit 62. Alternatively, the at least one transfer conveyor unit 73 can be a single conveyor unit that extends between the entry conveyor unit 74 and the exit conveyor unit 72. Typically, one or more of the rollers of at least one of the conveyor units 62 comprises an integrated driving motor, whilst the remaining rollers may be connected by belts to the driving roller, or they may be passive.

In another embodiment, an additional conveyor unit, termed a direction change conveyor unit 75, is integrated into the conveyor system 60. The additional conveyor unit or the directional change conveyor unit (not shown) comprises one or more rollers or belts or chains laterally disposed between or which interdigitate between the rollers of the transfer conveyor unit 73 and are arranged to be driven transversely to the transport direction of the transfer conveyor unit 73. The additional conveyor unit or directional change conveyor unit is lowered or raised by a lifting mechanism relative to the rollers of the transfer conveyor unit 73 such that in the raised position, the directional change conveyor unit is in contact with a storage container 9 causing the directional change conveyor unit to drag or pull the storage bin from the transfer conveyor unit 73 onto a separate surface in the buffer zone 70. The separate surface in the buffer zone 70 comprises an intermediate holding facility (not shown). Whilst the particular embodiment describes a lifting mechanism to engage the directional change conveyor unit 75 with a storage bin on a conveyor unit, other directional change conveyor units commonly known in the art of conveyor systems are applicable in the present invention such as conveyor balls and rail mounted trolleys.

A control system is used to actuate the movement of the conveyor units. The control system may send a signal to one or more driving motors, actuating the motors and causing movement of the conveyor units. Alternatively or additionally, one or more sensors may be used to detect the presence of one or more storage containers, and the sensors may send a signal to the control system, and the control system may actuate one or more driving motors to move one or more of the conveyor units.

The intermediate holding facility, which is part of the buffer zone 70, is configured to temporarily hold one or more items or storage containers 9 in the transfer system 56. These can be storage containers from the first automated storage and retrieval system 52 and/or from the second automated storage and retrieval system 54, or items from one or more storage containers. For example, the intermediate holding facility can hold large storage containers from the second automated storage and retrieval system 54, while small storage containers or items from small storage containers from the first automated storage and retrieval system 52 are picked and decanted into the large storage containers (see FIG. 11(a)).

The use of an intermediate holding facility can improve the efficiency of the automated handling system by removing the requirement for the storage containers from the first and second automated storage and retrieval systems to be in the transfer system at the same time. For example, an item from a small storage container of the first automated storage and retrieval system 52 can be picked from the storage container to the intermediate holding facility, and the item can remain in the intermediate holding facility until a large storage container from the second automated storage and retrieval system 54 arrives to the buffer zone 70 of the transfer system. Once the item has been picked, the small storage container of the first automated storage and retrieval system can be returned to the grid framework structure of the first automated storage and retrieval system 52 without having to wait until the large storage container from the second automated storage and retrieval system 54 is ready to receive the item. This improves efficiency because storage containers are no longer waiting and blocking the next storage container from being processed through the transfer system.

Whilst the at least one conveyor system in the particular embodiment of the present invention in FIG. 10 shows one conveyor system extending from the outlet port column to the inlet port column of the grid framework structure of the second automated storage and retrieval system, the at least one conveyor system can comprise a first conveyor system for transporting storage containers into and out of the grid framework structure of the first automated storage and retrieval system and a second conveyor system for transporting storage containers into and out of the grid framework structure of the second automated storage and retrieval system. Each of the first and second conveyor systems comprises an exit conveyor unit, an entry conveyor unit and a transfer conveyor unit, wherein the transfer conveyor unit extends between the exit and entry conveyor unit as discussed above. Thus, the first conveyor system transports the storage bin or container 9) from the outlet port column of the first automated storage and retrieval system to a picking station 64, and then back to the inlet port column of the first automated storage and retrieval system. Similarly, the second conveyor system transports a storage bin or container 9) from the outlet port column of the second automated storage and retrieval system to a decant station and then back to the inlet port column of the second automated storage and retrieval system. The pick station is located or positioned between the first and the second conveyor systems so that one or more items can be picked from the storage containers on the first conveyor system and deposited or decanted into storage containers on the second conveyor system.

In another exemplary embodiment of the present invention, the at least one conveyor system comprises at least one conveyor unit extending directly between the at least one port column of the grid framework structure of the first automated storage and retrieval system to the at least one port column of the grid framework structure of the second automated storage and retrieval system. Thus, the first and second automated storage and retrieval systems share the same conveyor system extending between their respective grid framework structures. As a result, the entry conveyor unit, exit conveyor unit and the transfer conveyor unit are shared between the first and second automated storage and retrieval systems.

### Weighing Cells

In the case where the conveyor system 60 comprises multiple conveyor units 62, one or more of the conveyor units 62 may comprise a weighing cell or alternatively, a weighing cell can be positioned anywhere along the conveyor system. The weighing cell is connected to at least one conveyor unit 62 and arranged to weigh a storage container 9. Alternatively or additionally, the intermediate holding facility and/or the picking station 64 may be provided with one or more weighing cells. The weighing cell can be a load cell or any other weighing cell commonly known in the art. A control panel may be configured to display the weight of the storage container 9 as items or other containers are picked from or loaded into the storage container. For example, when operated at a pick station, the weighing cell measures the weight of the storage container 9) as one or more items are picked from the storage container 9. A control system is used to monitor the weight of the storage container as items are picked from the storage container. This enables the control system to keep track of the weight of each of the storage containers stored within the grid framework structure.

The weighing cell prevents the storage container 9 being overloaded, which may prevent the bin lifting device and/or the lifting mechanism of the load handling device being able to lift the storage bin or container. The motors of the lifting mechanism of the load handling device and/or the bin lifting device are rated to a carry a predetermined weight. Once the predetermined weight has been reached, the display on the control panel will provide a notification to an operator, i.e. via the display panel, or send a signal to the control system, to indicate that the weight of a particular storage bin or container has been reached and no further items can be added to the storage bin before it is transported back into the automated storage and retrieval system. Additionally or alternatively, the lifting mechanism of the one or more bin lift devices can comprise a weighing cell to weigh a storage bin or container as it is lifted towards the grid framework structure.

### Bin Lift Device

Optionally, to prevent one or more storage bins or containers backing up in the transfer system 56, the transfer system 56 additionally comprises one or more bin lift devices so as to allow one or more storage bins to be vertically accumulated. The bin lift device comprises lifting arms and a lifting mechanism. In the particular embodiment of the present invention, the bin lift device comprises a pair of or two lifting arms. The space between the lifting arms is wide enough to allow a conveyor unit 62 to pass between the lifting arms as the lifting arms descend past the conveyor unit 62. In use, the lifting arms descend to a lowermost level below the conveyor unit 62 such that the lifting arms can engage with a bottom wall of the storage bin on the conveyor unit. The storage bin or container is lifted from a lowermost position on the conveyor unit 62 to an uppermost positon towards the grid structure 1 such that the storage bin is vertically spaced apart from the conveyor unit 62. This allows a second storage bin or container to enter the conveyor unit 62 and be vertically accumulated below the storage bin or container thereabove.

The bin lift device may be positioned above the entry conveyor unit 74 transporting storage containers into the grid framework structure 1. The entry conveyor unit 74 and bin lift device may be located in a port column 58 of the grid framework structure 1. The storage bin at the uppermost position waits until a load handling device 31 operative on the grid framework structure 1 at an upper level is able to retrieve the storage bin or container 9 through a port column 58. More specially, a grabber device 43 of the load handling device 31 is able to grab the storage bin or container 9 at the uppermost level and lift the storage bin or container 9 into a container receiving space of the load handling device 31. A sensor detects the retrieval of the storage bin at the uppermost level which sends a signal to a control system or controller to lower the lifting arms below the second storage bin or container resting on the entry conveyor unit 74 which is subsequently lifted to the uppermost level, allowing for a third storage bin or container queuing on the conveyor system to be lifted by the bin lift device.

A bin lift device can comprise multiple pairs of lifting arms that are vertically spaced apart so as to allow multiple storage bins to be vertically accumulated at different heights. For example, a first pair of lifting arms can be arranged to lift a first storage bin to a first height, a second pair of lifting arms can be arranged to lift a second storage bin to a second height and so on. This allows multiple storage bins to be vertically accumulated at different heights before being transported into the grid framework structure for storage. Added to this, one or more bin lift devices can be arranged adjacent to each other. To conserve space and to reduce the footprint of the transfer system 56, a first bin lift device can be arranged at the end of the conveyor system 60 so that a storage bin or container can be transported along the same path of conveyor system 60 into the first bin lifting device. If the first bin lifting device is fully occupied, the conveyor system can be instructed to re-direct the storage container into an adjacent second bin lift device perpendicular to the direction of the conveyor system 60. This can be achieved by controlling the movement of the container using a directional change conveyor unit 75, as described above, to transport the storage bin into the second bin lift device. Here the control system or a separate controller monitors the occupancy of the first bin lift device and the second bin lift device and decides whether to transport the storage bin into the first bin lift device or the second bin lift device depending on their occupancy. The occupancy of the bin lift device is determined by one or more sensors to detect the presence of a storage bin or container in the bin lift device. Examples of sensors include but are not limited to proximity sensor such as light sensors.

By having multiple bin lift devices allows a greater throughput of the storage bins or containers through the transfer system 56. The number of bin lifting devices is not limited to two and the entry conveyor unit 74 can be arranged to allow multiple bin lift devices to be at the receiving end of the transfer conveyor unit.

The one or more bin lift devices can comprise at least two guides for guiding the storage bin or container vertically as it is lifted by the lifting arms. In one embodiment, four guides are provided at the four corners of the bin lift device. The guides are received in the port column 58. Equally, brackets can be used to connect the uppermost part of the bin lifting device with the port column of the grid framework structure 1. The brackets comprise guides to guide the storage bin or container into the port column. This allows the bin lift device to be a separate part of the grid framework structure—hence, the ability to be retrofitted to an existing grid framework structure. The one or more bin lift devices comprise sidewalls or panels mounted externally to at least a portion of the guides to enclose the bin lift devices and prevent components of the bin lift device such as the lifting arms being exposed.

### Pick Station

FIG. 11(a) illustrates an embodiment of a pick station or picking station 64 in more detail. A conveyor unit 62 of the conveyor system 60 transports the large storage containers 9 from the second automated storage and retrieval system 52 to a location adjacent the pick station 64 so that items or the small storage containers 9 at the pick station can be transferred to the large storage containers 9. The small storage containers 9 are at the pick station, having been transported there by one or more port columns 58 of the first automated storage and retrieval system 52 (not shown). The small storage containers 9 in this embodiment are shallow trays 8 (see FIG. 11(b), with the item 6 stored within the trays 8 (see FIG. 11(b)). For the purpose of definition in the present invention, the term “shallow” tray is construed to mean a shallow container with a raised or upwardly extending lip or rim. The upwardly extending rim 8b of the shallow tray 8 ensures that the grabber device 39 of a load handling device 31 operative on the track system 13 is able to grip onto the storage container 9 comprising the shallow tray 8 and lift it from a stack 11. In the exemplary embodiment of the present invention, the grabber device 39 releasably engages with the upwardly extending rim of the shallow tray 8. The upwardly extending rim 8b also prevents the item 6 from falling off the shallow tray.

One of the problems of storing one or more items 6 within a traditional box-like structure of a storage container 9 comprising a bottom wall and upwardly extending opposing sidewalls and end walls is that, when held in a stack 11, the contents of the storage containers 9 are only accessible from the mouth or open end of the storage container. This requires a load handling device 31 operative on the track system 13 to lift the storage container 9 from its grid location in order to gain access to the contents of the storage container 9. However, in an event that one or more of the load handling devices 31 becomes inoperative on the track system 13, access to the interior of the storage containers, which are held in a stack 11, may become troublesome. In a worst case scenario, one or more storage containers 9 would have to be lifted from the stack 11 in order to retrieve and thus, gain access to the contents within the interior space of a target storage container 9 in the stack. To mitigate this problem, the contents 6 of the storage container 9) can be placed on an exterior wall of the storage container 9 instead of inside of the storage containers. This helps to expose the contents of the storage container so as to enable access to the contents of the storage containers from the sides of the storage containers. In the particular embodiment shown in FIG. 11(b), the use of a shallow tray 8 to store one or more items 6 allows easy access to the content of the storage container 9 from the side of the storage container and thereby, removing the need to lift the storage container in order to gain access to the open end of the storage container.

In order to stack a plurality of shallow trays 8 on top of one another, in an exemplary embodiment of the present invention, the shallow tray 8 is mounted on legs or stilts 8c so as to vertically space the shallow tray 8 above a vertically adjacent shallow tray 8 in a stack 11 in the grid framework structure 1. The stacking of the shallow trays 8 is illustrated in FIG. 7. As discussed above, the grid framework structure shown in FIG. 7 is an example of the grid framework structure of the first automated storage and retrieval system 52. FIG. 11(b) shows a perspective view of a storage container 9 in the form of shallow tray 8 mounted on legs 8c to raise the shallow tray 8 above a vertically adjacent storage container 9 below in a stack 11 according to an exemplary embodiment of the present invention. As clearly shown in FIG. 7, each of the shallow trays 8 in a stack 11 is vertically spaced apart from the other trays in the stack by means of the shallow trays 8 being mounted on legs or stilts 8c. Each of the legs 8c extends along the longitudinal length of the shallow tray 8 as shown in FIG. 11(b) but other means to vertically space the shallow trays in a stack 11 are applicable in the present invention, since it is not necessary to mount the shallow tray 8 on legs 8c to vertically raise the shallow tray 8. For example, the shallow tray 8 can form part of an external or exterior wall of a box-like structure having opposing sidewalls and end-walls. The use of legs to vertically raise the shallow tray helps to reduce the weight of the storage container. The legs 8c are configured to rest on the surface of the shallow tray 8 of a vertically adjacent storage container below in a stack 11 (see FIG. 7).

The upwardly extending rim 8b of the shallow tray functions as a barrier to prevent one or more items 6 in the shallow tray 8 from escaping from the storage container 9. In the particular embodiment shown in FIG. 11(b), the upwardly extending rim 8b comprises one or more cut-outs 8d to allow easy access to the interior of the shallow tray 8 from the side. As shown in FIG. 11(b), the cut-outs 8d in the rim of the shallow tray 8 are orientated such that the cut-outs 8d of vertically adjacent storage containers in a stack 11 are all facing in the same direction (or aligned) in the sense that the interiors of vertically adjacent shallows trays are exposed on one side of the stack, e.g. along an aisle in the grid framework structure. Should any one of the load handing devices 31 become inoperative on the track system 13, access to the contents of the storage containers 9 will still be possible through the cut-outs 8d in the rim of the shallow trays 8. Taking the example shown in FIG. 7, an operator can retrieve the contents 6 of the storage containers 9 by travelling along the aisles where the contents of the storage containers 9 are exposed.

To ensure that one or more items 6 is prevented from falling out of the shallow tray 8 when the storage containers are moved, the bottom wall 8e of the shallow tray 8 can be formed with a depression or a downwardly slopped bottom wall so that the one or more items 6 resting on the bottom wall 8e are directed towards the depression under their own weight. In the particular example shown in FIG. 11(b), the depression is concave shaped extending from the edge of the bottom wall 8e. Whilst the particular embodiment shown in FIG. 11(b) shows the storage container 9 as separate parts, the storage container 9) comprising the shallow tray 8 and upwardly extending rim 8b can be formed as a single integral body.

Returning to FIG. 11(a), a tilting mechanism 78 (not shown) tips the small storage containers or trays 9 to a tilted position, so that the items on the small storage trays slide off the trays through the cut-out or opening in the rim of the tray onto a tilted platform or slide 80. One or more robotic arms 76 are configured to pick up the items from the slide 80 and place them in the large storage containers 9 on the conveyor unit 62. The conveyor unit 62 transports the large storage containers 9 back to the grid framework structure of the second automated storage and retrieval system 52.

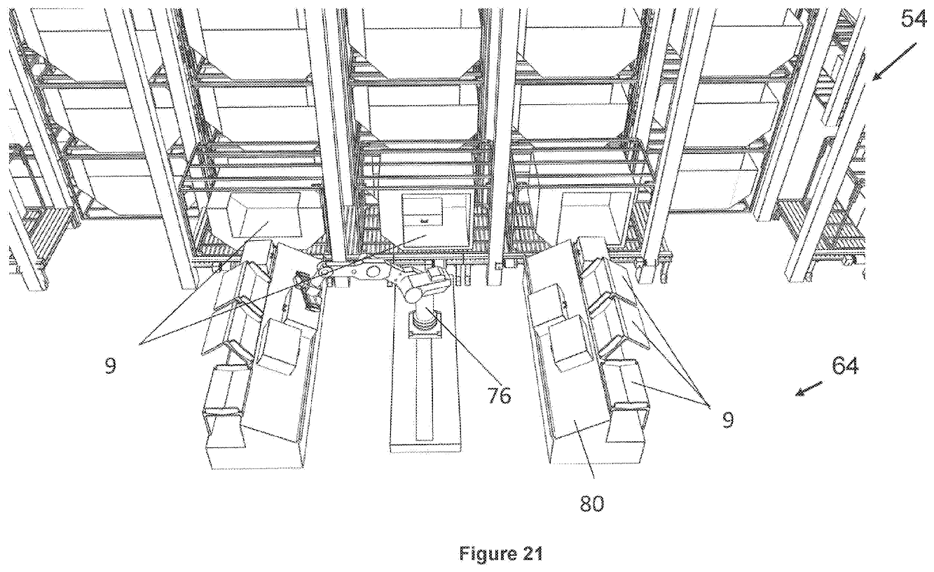

FIG. 21 illustrates the pick station 64 of FIG. 11, adjacent to the second automated storage and retrieval system 54. The storage containers 9 are retrieved from the grid framework structure 1 of the second automated storage and retrieval system 54 by load handling devices 31 and transferred to the pick station 64 via the port columns. The storage containers 9 are within reach of the robotic arm 76, so that the robotic arm can pick an item from the slide 80 of the pick station 64 and place it directly into one of the large storage containers 9.

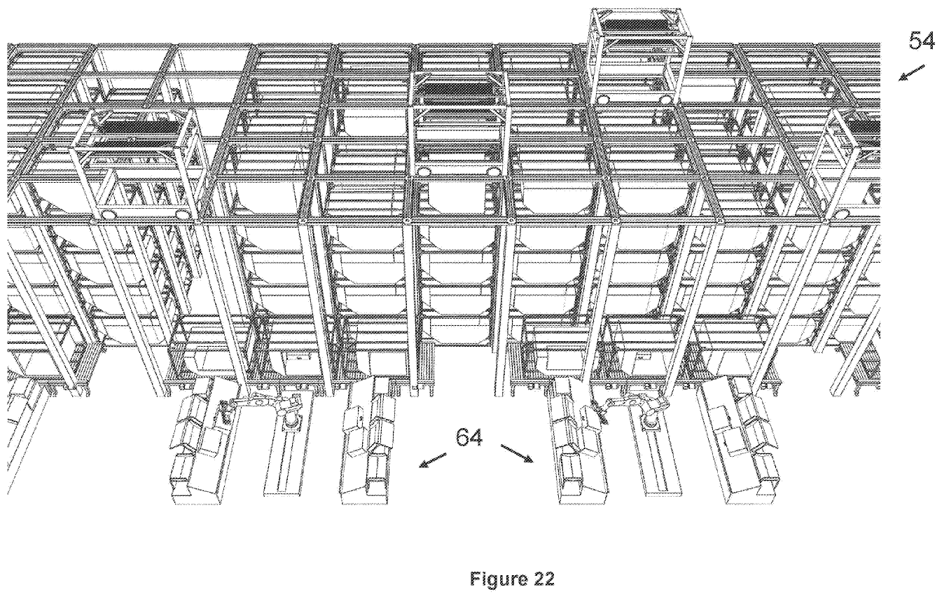

As illustrated in FIG. 22, multiple pick stations 64 may be located adjacent to the grid framework structure 1 of the second automated storage and retrieval system 54.

The transfer system 56 is used to bring the large storage containers 9 close to the pick station 64, so that the storage containers 9 are within reach of the robot arm 76.

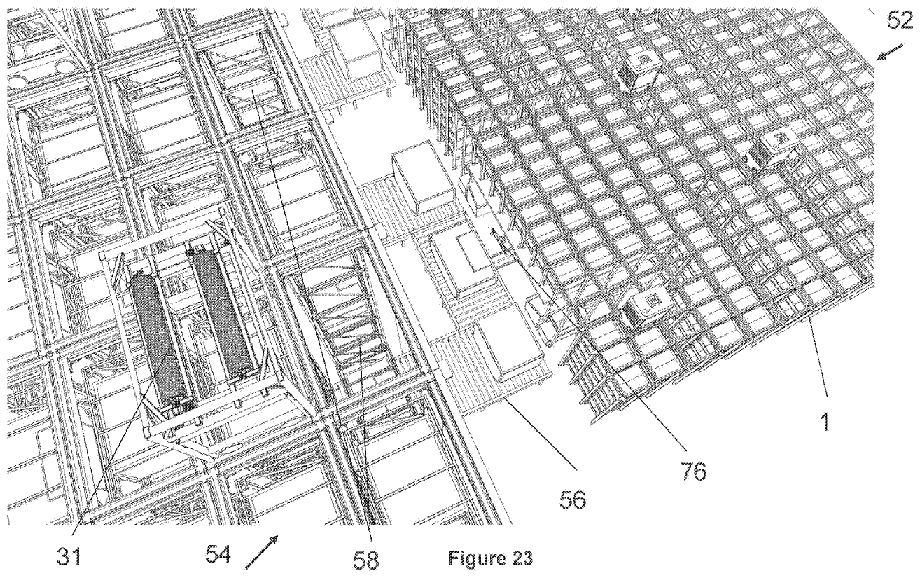

FIG. 23 shows the location of the transfer system 56 relative to the pick station 64. The pick station 64 is located under the grid framework structure 1 of the first automated storage and retrieval system 52. The gripper of the robotic arm 76 at the pick station 64 can just be seen under the grid framework structure 1. The transfer system 56 (in this illustration, the transfer system comprises a conveyor system 60) transports the large storage containers 9 to a position adjacent to the pick station 64, so that the storage containers 9 are within the reach of the robot arm 76. As can be seen from FIG. 23, port columns 58 are positioned directly above the transfer system 56, such that storage containers can be lowered down the port columns and onto the transfer system. Storage containers 9 can then be returned to the grid framework structure by being lifted up the port columns, and transported to a position in the grid framework structure by a load handling device 31. Multiple transfer systems can be arranged in the corridor between the grid framework structures of the first and second automated storage and retrieval systems, in order to make the best use of space and transfer items more efficiently.

In an embodiment of the present invention, the picking station can double up as a restocking station. The picking/restocking station has an access station that can function both as a picking station and/or a restocking station. The picking station 64 is part of the first automated storage and retrieval system, and cooperates with the second automated storage and retrieval system 52 to provide a system for retrieving one or more items from one or more storage containers 9 of the first automated storage and retrieval system and transferring them to the second automated storage and retrieval system. The picking station comprises one or more chutes forming a supply zone, an access station and one or more bin lift devices forming a pick station buffer zone. The chutes and bin lift devices are examples of port columns 58. By reference to its name, the one or more chutes allows a load handling device 31 operative on the grid framework structure 1 to lower a storage bin or container 9 without any lifting assistance from the one or more chutes. This could be under the action of gravity where the storage bin or container 9 is allowed to descend down the chute under the weight of the storage bin or container 9 and/or being lowered by the container lifting means 39 of the load handling device 31.

One or more items are picked from one or more storage bins or containers 9 in the access station depending on whether the access station functions as a pick station or a restocking station. The one or more chutes and the one or more bin lift devices are arranged to cooperate with the grid framework structure 1 above. The plurality of grid cells 14 comprises a drop off port (outlet port) and a pick-up port (inlet port) that are arranged to cooperate with the one or more chutes and the one or more bin lift devices respectively. More specifically, the storage column to which the drop off port and the pick-up port are located are arranged to respectively cooperate with the one or more chutes and the one or more bin lift devices of the picking station 64.

The picking station 64 of the present invention can be arranged as a standalone station that can be easily retrofitted to an existing grid framework structure 1 and therefore is able to cooperate with a track system running overhead. For example, the at least one chute and the at least one bin lift device can be aligned with one or more storage columns 10 so that a storage container or bin 9 can readily pass through the storage column 10 into the at least one chute. Equally, a storage bin or container 9) can be lifted from the at least one bin lift device and pass through the storage column 10. The pick station 64 can be of a modular construction wherein the supply zone, the access station and the pick station buffer zone can be formed as modules that are assembled together. As a result, the picking station 64 has no reliance to be connected to the grid framework structure 1 but can be formed as a separate part of the grid framework structure 1. The versatility of the picking station 64 to be retrofitted to an existing grid framework structure 1 allows the picking station 64 to be assembled in various locations.

In one embodiment, the picking station 64 comprises a standalone framework that divides the picking station into the supply zone, the pick station buffer zone and the access station. The one or more chutes of the supply zone comprises at least two vertical guides that are receivable in a storage column 10 and are arranged to guide a storage bin or container 9 down the storage column 10 into the supply zone via the drop-off port. In terms of definition, the storage column 10 in which the drop off port in the grid is located is termed a delivery column. Likewise, the storage column 10 in which the pick-up port in the grid is located is termed a retrieval column. In the particular embodiment of the present invention, each of the one or more chutes comprises four guides that are receivable in a storage column of the grid framework structure 1. Each of the guides comprises two perpendicular plates (two container guiding plates perpendicular to each other) that extend longitudinally along the length of the chute. One end of each of the guides is arranged to extend into a storage column or delivery column and butts up against the four upright members that make up the storage column. Thus, a storage bin or container 9 being lowered down a drop off port is guided down a chute of the supply zone by the guides via the delivery column (to which the drop off port is located).

Sidewalls or panels are mounted externally to the at least two vertical guides to enclose the vertical chutes. The sidewalls or paneling provides shielding to an operator from one or more storage bins or containers descending down the chute in the supply zone. In one embodiment, a first portion of the guides are covered by sidewalls or panels and a second portion of the guides are received in the delivery columns. This allows the sidewalls or panels to provide a seamless transition from the delivery column to the chute of the pick station 64.

Direct Transfer of Small Containers into Large Containers

The invention also encompasses embodiments where storage containers from one automated storage and retrieval system can be placed directly inside storage containers from another automated storage and retrieval system, rather than items being picked from one storage container into another storage container. Placing storage containers inside storage containers can be achieved in several different ways: a number of non-limiting examples are given below; but it will be appreciated that any means of placing a storage container inside another storage container is within the scope of the invention.

Small storage containers from the first automated storage and retrieval system 52 may be picked into large storage containers from the second automated storage and retrieval system 54 by means of one or more robotic arms 76, in a similar manner to as described above for picking individual items from the small storage containers. The robotic arms may have suitable end effectors with grippers which engage with features of the small storage container, such as a rim or lip or apertures, or the robotic arm may grip opposing sidewalls of the small container.

Alternatively a flat surface may be arranged over one or more conveyor units of the conveyor system, with one or more apertures in the flat surface such that an aperture is directly above a large storage container on the conveyor, providing access to the large storage container through the aperture in the flat surface. A small storage container may be lifted or dropped or slid into the large container through the aperture in the flat surface. A robotic arm may be used to lift the small container into the large container through the aperture. Alternatively another conveyor unit at the same vertical height as the flat surface can be used to convey the small container to the aperture so that the small container falls through the aperture and into the large container.

Another option is for the large container to have an aperture in one of its sidewalls, or a sidewall that can be removed, in order to provide access to the interior of the large container. The small container can be slid into the large container. A conveyor unit, at the same vertical height as the base of the large container, may be used to convey the small container into the large container. Alternatively, in a similar way to as described above with reference to FIG. 11(a), a slide or downwardly inclined surface may be used to allow the small container to slide down into the larger container through the aperture in the side wall of the larger container. This method has the advantage that the small container is not subjected to a vertical drop and thus avoids risk of damage to the contents of the small container.

### Automated Handling System

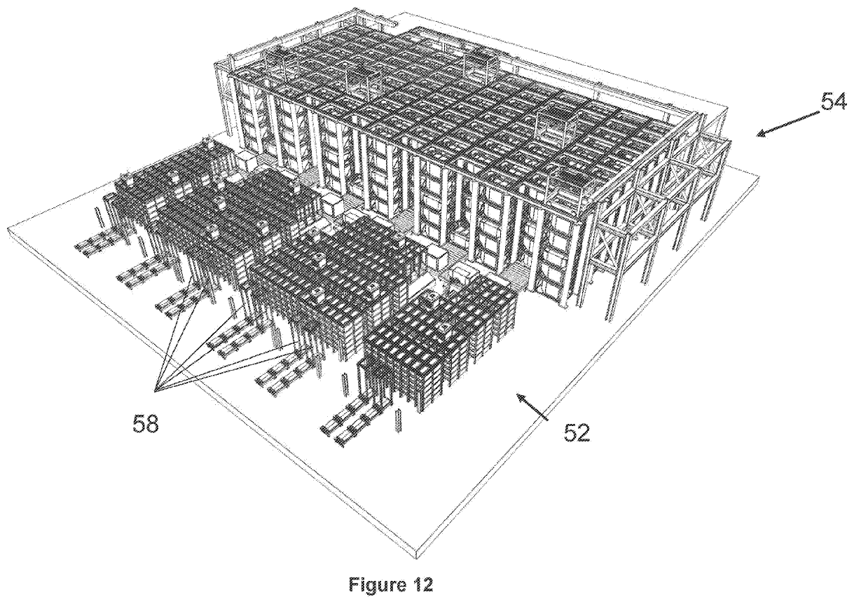

FIG. 12 schematically illustrates another view of an automated handling system 50 with first and second automated storage and retrieval systems and transfer systems. The first automated storage and retrieval system 52 is adjacent to the second automated storage and retrieval system 54. The first automated storage and retrieval system is provided with port columns 58 on the opposite side to the second automated storage and retrieval system. These port columns 58 transport containers into the first automated storage and retrieval system 52 and are defined herein as above as a pick-up port column. In the embodiment of the automated handling system 50 illustrated in FIG. 12, the grid framework structure 1 of the first automated storage and retrieval system 52 is divided into several subsections, and the port columns 58 are separated from the main grid framework structure. The invention encompasses embodiments where the grid framework structures 1 of any of the automated storage and retrieval systems are either one structure or divided into subsections, and embodiments where the port columns 58 are either integrated into a grid framework structure or subsections thereof, or separated from the grid framework structure.

For example, in applications where the automated handling system 50 is a baggage handling system at an airport or other transport hub, the items stored in the small containers of the first automated storage and retrieval system 52 may be passengers baggage or suitcases. After the passengers check in their baggage, the baggage may be transported to a receiving area adjacent to the first automated storage and retrieval system 52 (for example, by one or more conveyors, not shown), and each suitcase or item of baggage may be placed in one of the small storage containers 9. The small storage containers 9 are then transferred into the first automated storage and retrieval system 52 by means of the port columns 58. Load handling devices 31 operative on the grid framework structure 1 of the first automated storage and retrieval system 52 retrieve the small storage containers 9 containing the baggage and transport the containers to one or more port columns 58 on the side of the first automated storage and retrieval system 52 that is adjacent to the second automated storage and retrieval system 54; herein defined as above as a drop-off port column. The small containers 9 are transferred from the first automated storage and retrieval system 52 to one or more transfer systems 56 from the port columns. The one or more transfer systems 56 comprise pick stations 64 that pick the passengers' baggage out of the small containers of the first automated storage and retrieval system 52, and decant them into large storage containers in the transfer system, namely waiting at the buffer zone. One large storage container can accommodate multiple suitcases or items of baggage that are allocated to the same means of transport (e.g, the same flight) or the same destination. The large storage containers 9 are transported by the transfer system 56 to the second automated storage and retrieval system 54, and the large storage containers 9 are returned to the grid framework structure 1 of the second automated storage and retrieval system 54 via one or more port columns on the side of the second automated storage and retrieval system 54 adjacent to the transfer system 56. When the baggage is required, the large storage containers are retrieved from the second automated storage and retrieval system 54 by load handling devices 31 operative on the grid framework structure of the second automated storage and retrieval system. The large storage containers 9 are transported by the load handling devices to one or more port columns 58 on the opposite side of the grid framework structure 1 to the side adjacent to the transfer system. These port columns on the opposite side of the grid framework structure differ from the drop-off and pick-up port columns to and from the transfer system 56 in that they provide a secondary port column for one or more storage containers to exit the grid framework structure. The large storage containers 9 are transported out of the second automated storage and retrieval system 54 via their respective port columns. The large storage containers 9 can then be loaded into the cargo bay of a passenger transport vehicle such as a plane or boat or train or other transport means, so that the passengers' baggage can be transported to the appropriate destination.

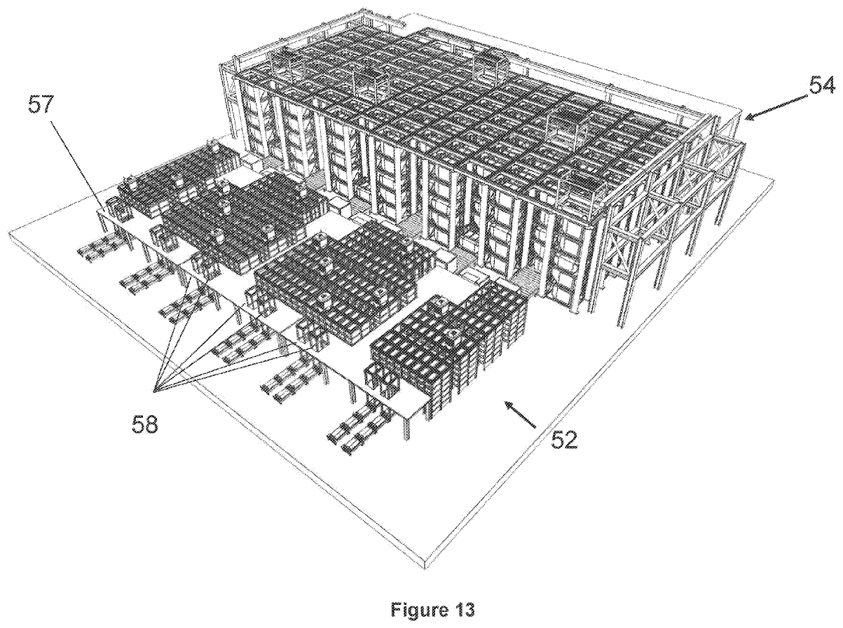

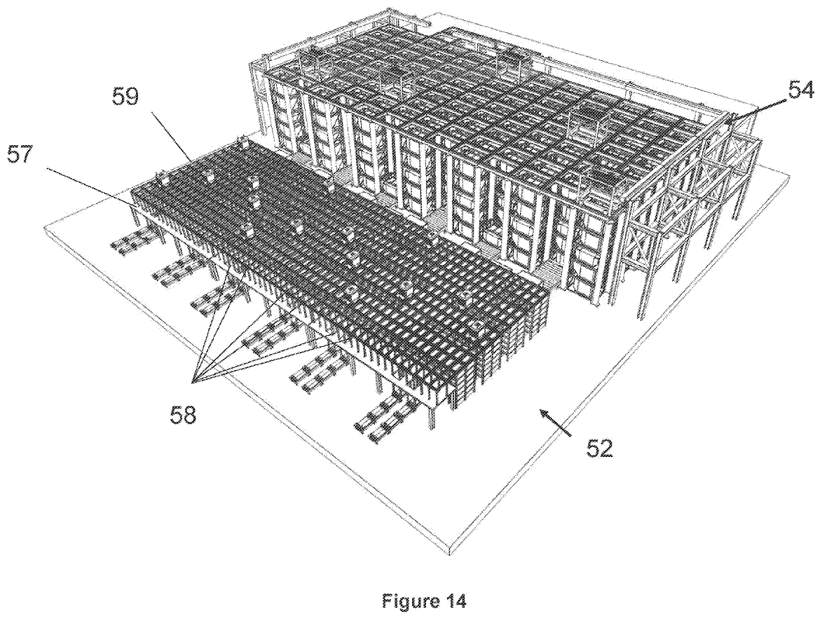

FIG. 13 schematically illustrates the automated handling system 50 of FIG. 12, with a platform 57 below the top layer of a section of the grid framework structure 1 of the first automated storage and retrieval system 52. The platform 57 provides an area for accommodating the port columns. FIG. 14 schematically illustrates the automated handling system 50 of FIG. 13, with a single-layer grid framework structure 59 on top of the platform 57. The single-layer grid framework structure 57 in this embodiment serves two purposes. Firstly, the single-layer grid framework structure 59 allows the load handling devices 31 to move between the port columns 58 and the grid framework structure 1 of the first automated storage and retrieval system 52, in order to transport storage containers from the port columns to the grid framework structure. Secondly, the single-layer grid framework structure 59 allows the load handling devices 31 to move between the different subsections of the grid framework structure 1 of the first automated storage and retrieval system 52, in order to transport storage containers between the subsections.

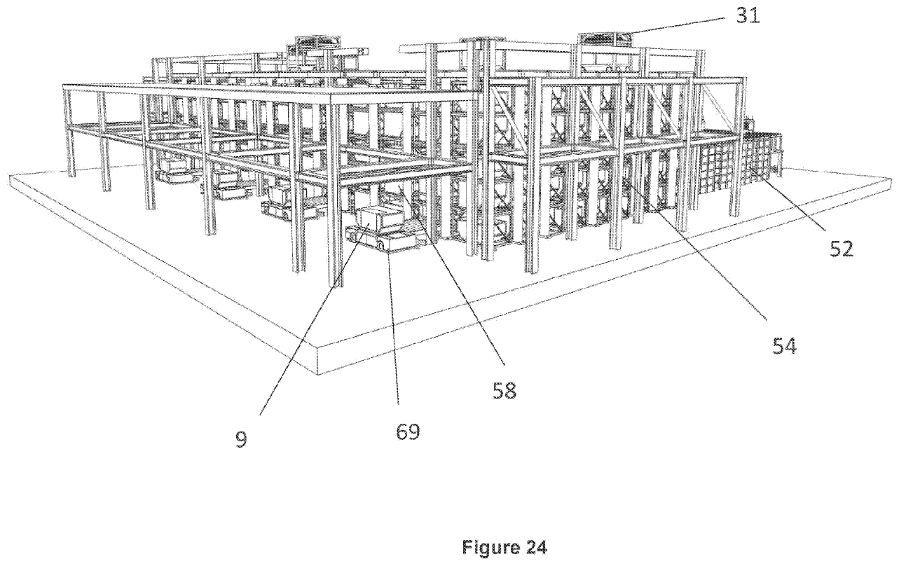

FIG. 24 is a schematic view of the back of the automated handling system of FIG. 12. The figure illustrates cargo dollies 69, upon which the large storage containers 9 are loaded. Each cargo dolly 69 is positioned near one of the port columns 58 of the grid framework structure 1 of the second automated storage and retrieval system 54. A storage container 9 is lowered down through the port column 58 and loaded onto the cargo dolly 69.

The cargo dolly 69 can be positioned directly below the port column 58 so that the storage container 9) can be lowered directly onto the cargo dolly 69. Alternatively, the cargo dolly can be positioned adjacent to the port column 58 and a conveyor unit located at the bottom of the port column 58 can be used to transfer the storage container from the port column 58 to the cargo dolly 69.

In applications where the automated handling system 50 is an automated baggage handling system, the large storage containers 9 are Unit Load Devices (ULDs), and contain baggage items. Once loaded, the cargo dollies transport the ULDs to the passenger transport vehicle (e.g. plane, train, or ship) and are loaded into the cargo hold.

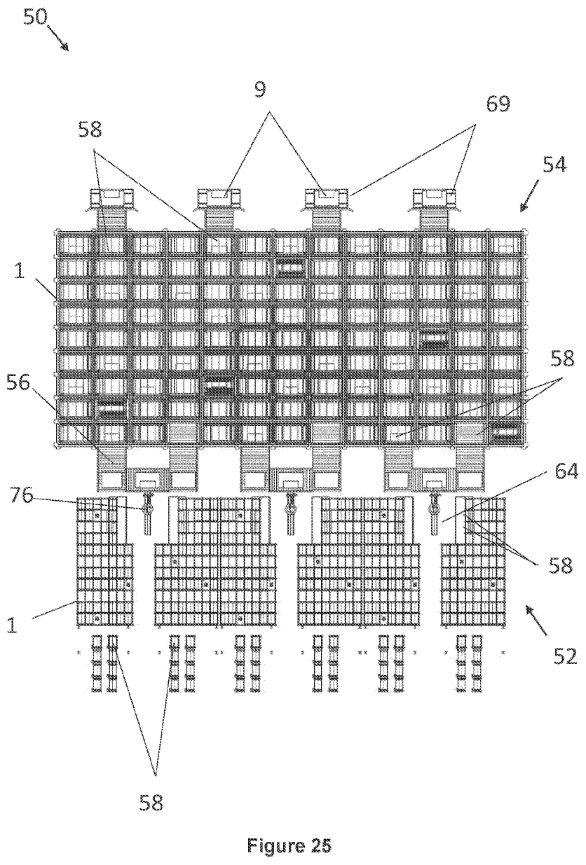

FIG. 25 is a schematic plan view of the automated handling system. Small storage containers 9) enter the automated handling system 50 through port columns 58 of the first automated storage and retrieval system 52: in FIG. 25 rows of storage containers can be seen queueing by the port columns 58 waiting to enter the grid framework structure 1. Once stored in the grid framework structure 1 of the first automated storage and retrieval system 52, the small storage containers 9 are transported by load handling devices 31 to port columns 58, through which they descend to a pick station 64. At the pick station 64, the robotic arm 76 picks items from the small storage containers into large storage containers which are waiting at the transfer system 56, namely at the buffer zone. Once full, the large storage containers are carried by the transfer system to port columns 58 of the second automated storage and retrieval system 54. The large storage containers ascend through the portal columns 58 into the grid framework structure 1 of the second automated storage and retrieval system, and are transported to a location within the grid framework structure by load handling devices 31 for storage. When the large storage containers are required, they are transported from the grid framework structure to the portal columns 58 on the opposite side, lowered down through the port columns 58 and loaded onto cargo dollies 69.

### Automated Assembly Line

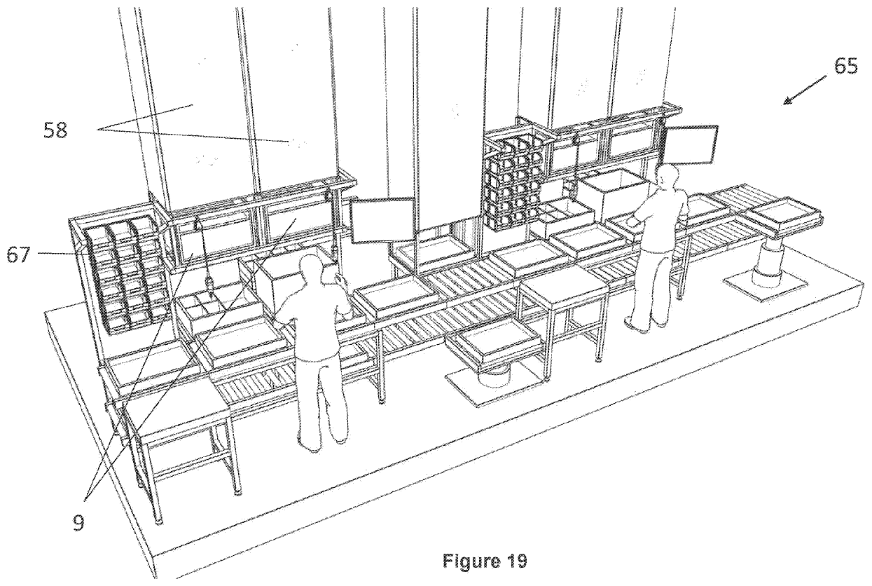

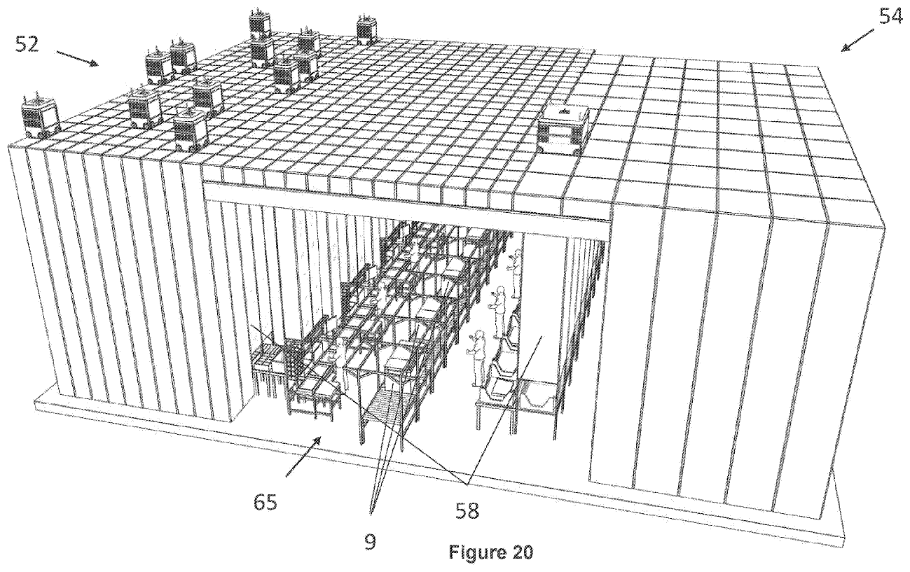

Another application for the automated handling system 50 is an automated assembly system. In this application, the items stored in the first automated storage and retrieval system 52 are parts to be assembled, and the items stored in the second automated storage and retrieval system 54 are assemblies of parts or final products. The transfer system comprises one or more assembly stations 65, in which the parts are assembled (see FIGS. 19 and 20). The parts may be assembled by human operatives, and/or by robotic arms.

Storage containers are retrieved from the grid framework structure 1 of the first automated storage and retrieval system 52 by load handling devices 31, and brought via one or more port columns to an assembly station 65. At the assembly station 65, the parts from the small storage containers from the first automated storage and retrieval system 52 are assembled into assemblies or final products. The assemblies or products are then placed into large storage containers at the buffer zone 70. The large storage containers containing the final products or assemblies are then transported via the transfer system to a port column 58 of the second automated storage and retrieval system. The large storage containers are transported up the port column 58 (pick-up port column) and transferred to a location for storage within the second automated storage and retrieval system by one or more load handling devices 31.

FIG. 19 illustrates an exemplary embodiment of an assembly station. Port columns 58 transfer storage containers 9 from the first automated storage and retrieval system to the assembly station 65. The small storage containers contain parts for assembly. FIG. 19 also illustrates racks 67, which may contain small parts or fittings (e.g. screws, nuts, bolts) that are required for assembly. In the embodiment illustrated in FIG. 19, the assembly is carried out by human operatives on trays located on a conveyor system. Each tray holds one assembly, and the trays may be passed down the assembly line from one human operative to the next operative in the line, so that different human operatives can add different parts to the assembly. When an assembly is complete, the tray can be placed in a large storage container (not pictured) ready to be taken to the second automated storage and retrieval system by the transfer system.

For example, if the automated assembly system is for assembling bicycles, the small storage containers contain bicycle parts (wheels, frame, gears, chains, brakes, saddles, handlebars etc.) and the large storage containers are for storing assembled bicycles. The first human operative in the assembly line retrieves a bicycle frame from one small storage container and wheels from another small storage container. The operative assembles the bicycle wheels to the bicycle frame, using bolts from the racks 67, and place the part-assembled bicycle on an assembly tray. The assembly tray is then passed down the assembly line, e.g. by means of a conveyor system, to the next operative in the line. The next operative in the line receives the assembly tray, takes a set of handlebars from another small storage container, and assembles the handlebars to the bicycle frame. The assembly tray passes to the next operative in line, who affixes the gears to the bicycle frame. In this manner the bicycle passes down the assembly line until all parts have been assembled. The finished bicycle is placed into a large storage container, and transported into the second automated storage and retrieval system.

FIG. 20 illustrates an automated assembly system incorporating the assembly station of FIG. 19. The automated assembly system comprises a first automated storage and retrieval system 52 and a second automated storage and retrieval system 54. The assembly station is located between the two automated storage and retrieval systems, below the track system of the grid framework structures. The small load handling devices 31 of the first automated storage and retrieval system retrieve small storage containers from the grid framework structure and bring them to the port columns 58, after which the storage containers descend down the port columns to the assembly station. The parts are assembled into products or assemblies at the assembly station, then the completed products or assemblies are placed in the large storage containers 9. The large storage containers are then transferred to the second automated storage and retrieval system by means of one or more port columns.

Although not pictured in FIG. 20, conveyors may be used to transport the large storage containers 9 from the assembly station 65 to the port columns 58 of the second automated storage and retrieval system, so that the storage containers can be returned to the grid framework structure of the second automated storage and retrieval system.

### Control System

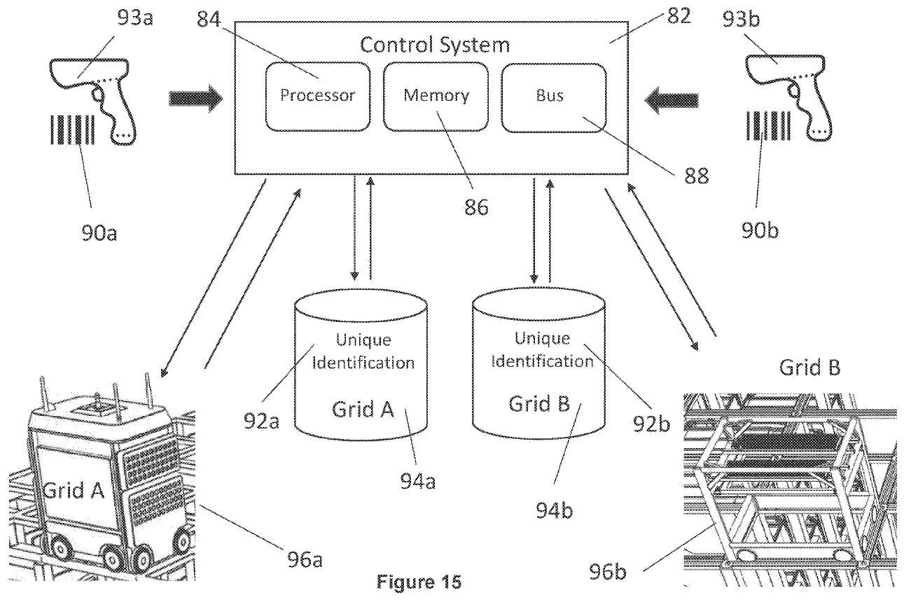

In an exemplary embodiment of the present invention shown in FIG. 15, a control system 82 coordinates the movement of one or more storage containers 9 or one or more items from the storage containers from the grid framework structure 1 of the first automated storage and retrieval system 52 for storage in the grid framework structure of the second automated storage and retrieval system 54. For ease of explanation and efficiency, the grid framework structure of the first automated storage and retrieval system 52 is termed “Grid A” and the grid framework structure of the second automated storage and retrieval system 54 is termed “Grid B”. In accordance with the present invention discussed above, Grid A is mismatched with Grid B in the sense that they respectively store differently sized storage containers or totes. The intention is that a plurality of storage containers, or the contents of a plurality of storage containers, from Grid A can be consolidated or collated for storage into a single storage container from Grid B. In order to consolidate the contents of multiple storage containers from Grid A to a single storage container in Grid B, the storage containers in Grid A are smaller than the storage containers in Grid B. As a result, Grid B is configured to accommodate the larger storage containers by having larger grid openings 15 than the grid openings 15 of Grid A. FIG. 15 is a block diagram showing the components of the automated handling system 50 according to an exemplary embodiment of the present invention. The control system 82 comprises one or more processors 84, a memory 86 (e.g. read only memory and random access memory) and a communication bus 88. The one or more processors 84 of the control system 82 can execute instructions stored in the ROM and/or RAM to at least partially provide the functionality of the automated load handling system described herein. The one or more processors 84 of the control system 82 are communicatively coupled to a wireless/wired transmitter receiver (not shown) via the communication bus 88. The cloud (not shown) may form part of the control system such that processing and storage of data can be carried out in the cloud. The control system 82 is instructed to execute instructions operable to receive a request for the transfer or shipment of one or more items or goods and generate a unique identification 92(a and b) to that request which is communicated to a user's personal communication device over a wired/wireless network. The unique identification 92(a and b) comprises data associated with the user. The data can be represented as a tier system where data associated with the user can represent a Tier 1 identification, and depending on the application of the automated load handling system of the present invention, the data can include other attributes associated with the user, e.g. flight data as Tier 2 identification where the automated load handling system is an automated baggage handling system. The Tier system allows the control system to identify and consolidate storage containers in Grid A based on a particular attribute of the unique identification. This could be a Tier 1 data associated with the user and/or a lower Tier data, e.g. flight data, where one or more storage containers for a particular flight are consolidated together for transfer to a single storage container in Grid B. Following a request to consolidate one or more storage containers in Grid A based on a particular attribute of their respective unique identification, the control system identifies the relevant storage containers in Grid A based on the particular attribute of their respective unique identifications. This could be associated with the user details or something lower down in the tier system.

Whilst the automated load handling device is applicable to any application requiring collation or consolidation of items, for ease of explanation of the functionality of the control system for coordinating the movement of one or more storage containers for consolidation into a single storage container, the automated load handling system will be described with respect to an automated baggage handling system. In the case of an automated baggage handling system, the users can include passengers and the unique identification comprises data associated with a user defined destination and/or travel data, e.g. flight details.

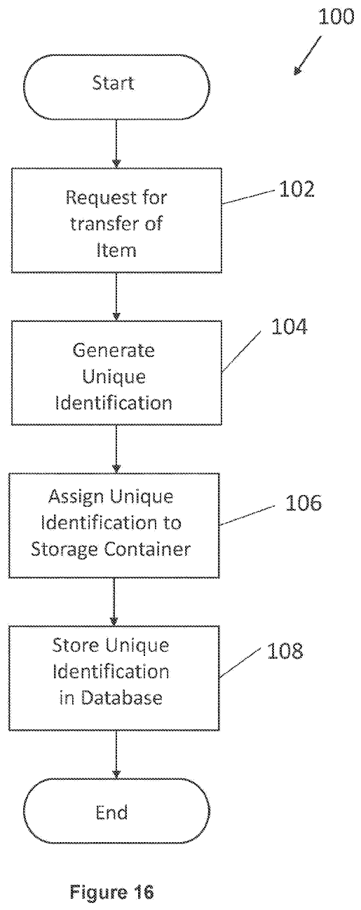

With reference to the flowchart shown in FIG. 16 in conjunction with FIG. 15, the process 100 allocating a unique identification 92(a and b) to a storage container in a grid framework structure begins with one or more users requesting one or more items to be held for transfer to a user defined destination at step 102. For an automated baggage handling system, the one or more items can be one or more baggage or luggage items. At the check-in desk, the control system generates at step 104 a label or baggage identification tag 90a comprising a unique identification 92 associated with the user as a Tier 1 identification and the user defined destination together with other travel data as Tier 2 identification and so on. The label 90a comprising the unique identification can be encoded into a barcode. 1-D barcode. 2-D barcode, or a QR code or a RFID tag. The label 90a is readable by a user interface 93a for establishing an identity of luggage in storage. The baggage or luggage is then deposited into a storage container for subsequent transfer to Grid A where it is stored prior to being consolidated into a large storage container in Grid B. A similar process of the generation of a unique identification 92b comprising data associated with a particular attribute of a storage container held in Grid B is applicable in the present invention. The relationship between the unique identification 92(a and b) between the storage containers held in Grid A and Grid B is further discussed below and depends on the particular application of the automated load handling system. For example, the relationship could be travel data in the case where the automated load handling system is an automated baggage handling system.

To locate the storage container to a particular user, the control system 82 assigns the generated unique identification to a storage container held in Grid A at step 106. The process of assigning the generated unique identification to a storage container in Grid A can include assigning the unique identification associated with the user to a grid location of the storage container in Grid A. The grid location can be represented by a Cartesian coordinate system, X, Y, Z. For the purpose of the present invention, the track system 13 guides the movement of the robotic load handling devices 31 in an X and Y direction in a horizontal plane above the track system 13 and the lifting mechanism 39 is configured to move the grabber device 43 in a third Z direction in order to access the storage container 9 below in a stack 11. For the purpose of the present application. Z=1 defines the uppermost layer of the grid framework structure 1. i.e. the layer immediately below the track system 13. Z=2 is the second layer below the track system 13. Z=3 is the third layer below the track system 13 and so on. The position of each of the storage containers 9 held in the grid framework structure 1 of the first and the second storage and retrieval systems (Grid A and B) 52, 54 can be represented by a Cartesian coordinate system, X, Y, Z. For example, a storage container can be said to be positioned in a grid location determined from the Cartesian coordinate system, X, Y, Z. The unique identification 92a can include data associated with the user as Tier 1 identification, travel data as a Tier 2 identification, and grid location of the storage container associated with the user as a Tier 3 identification.

Movement of the storage containers to and from their respective grid locations in Grid A is carried out by one or more robotic load handling devices 96a operative on the track system 13 of Grid A. Typically, one or more load handling devices 96a remotely operable on the grid framework structure are configured to receive instructions from a master controller, to retrieve a storage container 9 from a particular storage location within the grid framework structure. The master controller can form part of the control system 82 discussed with reference to FIG. 15. Wireless communications and networks may be used to provide the communication infrastructure from the master controller via one or more base stations to the one or more load handling devices operative on the grid framework structure. A controller in the robotic load handling device in response to receiving the instructions is configured to control various driving mechanisms to control the movement of the load handling device. For example, the load handling device may be instructed to retrieve a storage container 9 from a storage column 10 at a particular location on the grid framework structure. A storage column 10 has a particular X, Y coordinate of the Cartesian coordinate system and the depth of the storage column 10 can be represented by the Z coordinate. The instruction can include various movements in an X-Y direction on the grid framework structure. Once at the storage column 10, the lifting mechanism 39 operating in the Z-direction is then operated to grab the storage container 9 and lift it into a container receiving space in the body 33 of the load handling device 31 where it is subsequently transported to another location on the grid framework structure commonly known as a drop off port, where it is lowered in a port column 58. The instruction includes movement of the storage container 9 to and from its grid location to at least one port column 58 of Grid A where the storage container 9 can be dropped off. Once a user has checked his/her baggage at the check in desk and the baggage associated with the user has been allotted a unique identification 92a and placed in a storage container 9, the storage container 9 is moved by a load handling device 31 operative on the track system 13 to a grid location in Grid A. This could be a designated grid location assigned by the control system 82 or a grid location chosen by a user at the check-in desk. The grid location of the storage container in Grid A is assigned to the unique identification 92a associated with the user as discussed above. The process repeats for different users at the check-in desks.

As a result, the allocation and the movement of the storage containers for storage in Grid A, as well as assigning the unique identification to the grid location of the storage containers in Grid A, is an automated process that occurs in the background or back office away from the user. This is in comparison to the need to manually remove the baggage from a conveyor and onto a loading station for subsequent transfer to a ULD currently practiced in the art. In the present invention, the high density of storage of the grid framework structure according to the present invention allows multiple baggage items from different users to be transferred to Grid A for sortation, where they are subsequently transferred to a storage container in Grid B. The operation of a plurality of automated storage and retrieval systems where each automated storage and retrieval system comprises a grid framework structure 1 and a plurality of load handling devices 31 operative on the grid framework structure for moving storage containers from their grid locations to a port column, permits storage containers held in one grid framework structure to be sorted and/or rearranged for transfer to a storage container in another grid framework structure. Assigning at step 106 a unique identification 92(a and b) to the storage containers helps one or more items from one grid framework structure to be sorted and/or consolidated for transfer to a storage container in another grid framework structure.

The unique identification 92a for the different users can be stored in a database 94a (hereinafter termed “Grid A Database” in FIG. 15) in step 108. The database is communicatively coupled with the control system 82. As shown in FIG. 15, the Grid A database 94a in communication with the control system 82 contains information associated with the user (passenger). The information include the unique identification associated with the user, and/or how much remaining space is available within a designated storage container, and/or the size/dimensions/volume/weight of the baggage, and/or the grid location of the storage container within Grid A. or other relevant information in a Tier system. A unique identification 92a that identifies each storage container can be included on a label 90a affixed to the storage container, so that the storage container can be identified by scanning the label by an input device 93a (see FIG. 15). The input device 93a includes but is not limited to a radio frequency identification reader, a linear and/or matrix barcode reader, or an infra-red reader. The database can store associations between baggage items, for example, which baggage items belong to the same user or the same shipment. The storage containers are held in Grid A until they are needed to be transferred for consolidation to one or more larger storage containers in Grid B.

A similar database 94b is provided in communication with the control system 82 for the storage of information associated with the storage containers held in Grid B of the second automated storage and retrieval system 54. The storage containers held in Grid B are of a different size to the storage containers in Grid A and are intended to store items or storage containers consolidated and transferred from Grid A to Grid B. Like the unique identification 92a associated with one or more users in Grid A, the unique information 92b comprises data associated with a storage container held in Grid B and can comprise information on the grid location of the storage container in Grid B, how much remaining space is available within a designated storage container, and/or the size/dimensions/volume/weight of the storage container, and/or the grid location of the storage container within Grid B, or other relevant information in a Tier system. Like the storage containers held in Grid A, the unique identification 92b associated with the storage containers held in Grid B can be identified by a label or tag 90b affixed to the storage container. An input device 93b at the transfer system 56, e.g. at the buffer zone 70, can identify the storage container from Grid B from the label or tag 90b.

In the case of an automated baggage handling system, the storage container in Grid B can be a unit load device (ULD) that is used to load luggage or freight into a vehicle, e.g. aircraft, train or ship. Similarly to the grid location of the storage containers in Grid A, the grid location of the storage containers in Grid B can be represented by a Cartesian coordinate system, X, Y, Z. The difference between Grid A and Grid B is the size of the respective grid framework structures with the grid opening 15 in Grid A being smaller than the grid opening 15 in Grid B. Similarly to Grid A of the first automated storage and retrieval system 52, one or more load handling devices 31 operative on the track system 13 of Grid B are instructed to move one or more storage containers 9 to and/or from their respective grid locations to be dropped off at a port column 58 in Grid B. The instruction includes movement of the storage containers 9 to and from their respective grid locations to at least one port column 58 of Grid B. As discussed above, the load handling device comprises a wheel assembly for moving in the X and Y direction on the track system 13 and a grabber device 43 for grabbing a storage container 9 from its grid location into a container receiving space of the load handling device 31.

Whilst the exemplary embodiment in FIG. 15 shows two databases 94, one 94a for storing data associated with the unique identification 92a of storage containers from Grid A and the other 94b for storing data associated with the unique identification 92b of storage containers from Grid B, the data from both unique identifications 92 (a and b) can be stored in a single database 94.

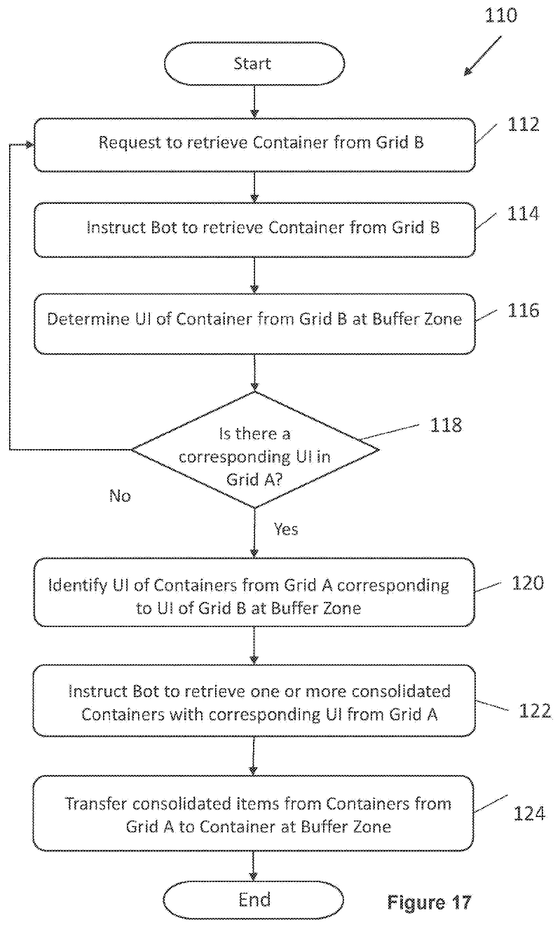

An exemplary embodiment of the sortation at step 110 of the storage containers from Grid A for consolidation into a particular storage container in Grid B having a unique identification 92(a and b) can be explained with reference to the flowchart in FIG. 17. For the ease of explanation, the term “unique identification” has been abbreviated to “UI” and load handling device has been abbreviated to “bot” in FIG. 17. The process begins with the control system 82 instructing a load handling device 31 operative on the track system 13 of Grid B to locate and retrieve a storage container 9 from its grid location to a drop off port where it is subsequently lowered through the at least one port column 58 and transferred by the at least one transfer system 56 to the buffer zone 70 in steps 112, 114. The request 112 to retrieve the storage container from Grid B may be dependent on the need to consolidate the items from Grid A into a storage container from Grid B.

Movement of the storage containers by the at least one transfer system 56 from the at least one port column 58 discussed above involves one or more conveyor units 62. The buffer zone 70 represents the portion of the at least one transfer system 56 where one or more storage containers 9 from Grid B are held whilst being loaded with one or more items or storage containers from Grid A. At the buffer zone 70, the identity of the storage container is determined by determining the unique identification 92b of the storage container using an input device 93b at step 116. The input device 93b could be a scanner, e.g. barcode scanner. QR code reader or other input device for determining the unique identification 92b of the storage container. Input of the unique identification 92b into the control system 82 can be by a manual operation, e.g. hand held scanner, or an automated operation, e.g, a mounted scanner. Once the identity of the storage container has been determined from its respective unique identification, the control system determines and locates storage containers held in Grid A having a corresponding unique identification 92a at step 118. The correspondence between the unique identification of the storage containers in Grid A and Grid B is based on the application of the automated load handling system of the present invention. In the case of the example of the automated baggage handling system, the correspondence between the unique identification between the storage container from Grid B and the storage containers from Grid A could be travel details, e.g. flight number or user defined destination. The label of the storage container from Grid B can include data associated with flight details, destination etc. The control system 82 can search the database of the unique identification associated with the user to identify any corresponding flight details stored with the unique identification 92(a and b) which may be held in a tier system, e.g. Tier 2 identification.

The control system 82 identifies one or more storage containers in Grid A having a corresponding unique identification 92a to the unique identification 92b of the storage container from Grid B at the buffer zone 70. Once identified, the control system 82 instructs one or more load handling devices 31 operative on the track system 13 of Grid A to retrieve the identified storage containers 9 and move the storage containers to be dropped off down the at the least one port column 58 to a pick station 64 at step 122. At the pick station 64, one or more items from the different storage containers from Grid A are transferred to the storage container at the buffer zone 70 where they are consolidated in the storage container at the buffer zone 70 in step 124. In the case of an automated baggage handling system, the one or more items can be luggage and the storage container at the buffer zone can be a unit load device (ULD). The luggage or baggage from the different storage containers at the pick station transferred to the ULD at the buffer zone. The control system 82 ensures that the unique identification 92a of the storage containers containing the baggage from Grid A corresponds to the unique identification 92b of the ULD at the buffer zone 70, e.g. flight details and destination. Automation of the allocation of baggage from Grid A for transfer to a ULD in Grid B removes any misplaced baggage being loaded into the wrong ULD as a result of human error. An input device 93a at the pick station 64 ensures that the unique identification 92a of the storage containers correspond to the unique identification 92b of the storage container at the buffer zone 70 so as to prevent the wrong items being loaded into the storage container at the buffer zone, and therefore provides a failsafe mechanism.

The transfer of one or more items from the storage containers at the pick station 64 to the storage container at the buffer zone 70 can be a manual operation. However, to increase automation of the automated load handling system 50 of the present invention, the picking of the items from the storage containers 9 at the pick station 64 where they are transferred to be consolidated into the storage container at the buffer zone 70 can be automated via the use of a robotic arm 76 that is able to grab the items from the storage containers and transfer them to the storage container at the buffer zone, as illustrated in FIG. 10. Whilst the exemplary embodiment describes picking one or more items to be transferred to the storage container at the buffer zone 70, storage containers themselves deposited at the picking station 64 can be transferred to be loaded into the storage container at the buffer zone. Equally applicable in the present invention is that the storage containers 9 can comprise an outer storage container and an inner storage container, otherwise known as a delivery container. The delivery containers from one or more storage containers at the pick station 64 can be transferred to a larger storage container at the buffer zone 70. Once the one or more items (baggage) from one or more storage containers are consolidated into a storage container at the buffer zone, the storage container at the buffer zone is moved to the at least one port column 58 of Grid B where it can be subsequently picked up by a load handling device 31 operative on the track system 13 of Grid B and transferred to a grid location in Grid B where it can be subsequently stored for later use. In the case of an automated baggage handling system, the ULD held in Grid B is subsequently retrieved by a load handling device 31 operative on the track system 13 of Grid B when it is required to be loaded onto a vehicle, e.g. into an airplane cargo hold. When requested to be loaded onto an airplane cargo hold, the control system 82 can instruct a robotic load handling device 31 operative on the track system 13 of Grid B to retrieve a ULD based on its associated unique identification 92b and deposit the ULD to at least one port column 58 wherein it can be loaded onto a suitable cargo dolly for transport to an airplane cargo hold.

However, if there are no storage containers that can be identified from Grid A having a corresponding unique identification, then the control system requests another storage container from Grid B. The absence of the storage container from Grid A having a corresponding unique identification may be due to a delay in the allocation of the storage containers in their respective grid location in Grid A. Alternatively, in this scenario the storage container from Grid B can optionally be retrieved from the grid and held in an intermediate holding facility 71 at the buffer zone 70, until the storage containers from Grid A have been allocated.

Whilst the exemplary embodiment in the flowchart in FIG. 17 begins with the control system 82 instructing a load handling device 31 to retrieve a storage container from Grid B prior to identifying storage containers in Grid A with a corresponding unique identification 92, the reverse is applicable where the control system identifies a storage container from Grid B with a corresponding unique identification to one or more storage containers being at the port column from Grid A.

Equally plausible in the present invention is that the at least one transfer system 56 can comprise at least one conveyor unit 62 to transfer one or more storage containers directly from the at least one port column 58 of Grid A to the at least one port column 58 of Grid B. Whilst the exemplary embodiment in FIG. 17 describes the automated load handling system 50 as an automated baggage handling system, the automated load handling system 50 of the present invention can be used in other applications requiring sortation and/or collation of items. The use of at least two automated storage and retrieval systems 52, 54, each of the at least two automated storage and retrieval systems comprising a grid framework structure 1 described above allows one or more items to be sorted and to be collated or consolidated from one storage container to another larger storage container.

The advantage of collating or consolidating one or more items using the automated load handling system 50 having a first and a second automated storage and retrieval system 52, 54 and at least one transfer system 56 linking them together, is that the automated load handling system 50 of the present invention can also find uses in an assembly line in a manufacturing process. For example, items from the first automated storage and retrieval system 52 can be consolidated and assembled into a product that can form part of a machine, e.g. pump, motor, or an entire product, e.g. bicycle, washing machine etc. Thus, instead of the unique identification 92(a and b) comprising data associated with one or more users as discussed above, the unique identification 92(a and b) can comprise data associated with at least a portion of a product or the entirety of a product in an assembly line such that the product is created when the items are assembled together. In other words, the one or more items can be envisaged to represent one or more parts of at least a portion of a product in an assembly line. As a result, the unique identification 92(a and b) comprises data associated with a product or at least a portion of a product. One or more items from one or more storage containers 9 can be consolidated or collated together based on their respective unique identification 92(a and b) being associated with at least a portion of a product to be assembled at an assembly station 65. As a result, the at least one transfer system 56 can further comprise an assembly station 65 for the assembly of one or more items or parts retrieved from Grid A prior to the assembled product being transferred to Grid B.

The unique identification 92a of the storage containers in Grid A can be associated with the at least a portion of a product or a product that is to be assembled at the assembly station 65. Thus, the database 94a for Grid A comprises data associated with the unique identification 92(a and b) of a product or at least a portion of a product to be assembled at the assembly station as a Tier 1 identification and their corresponding grid location as a Tier 2 identification. The assembled product can then be transferred to a storage container 9 at the buffer zone 70 for subsequent storage in Grid B. The storage container 9 in Grid B has a unique identification 92b that corresponds to the unique identification of the product assembled at the assembly station 65. As discussed above, the database 94b for Grid B comprises data associated with the assembled products and their grid location in Grid B. The operation of labelling the items and/or storage containers with information related to their respective unique identification 92 and inputting the unique identification 92 into the control system 82 by an input device is as described above.

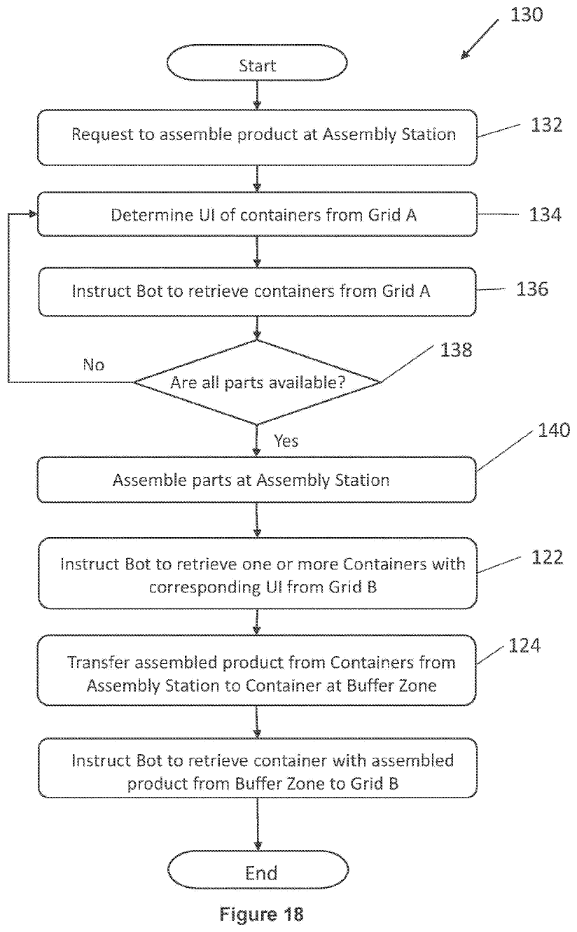

FIG. 18 shows the exemplary steps in the process of assembling at least a portion of a product 130 using the automated load handling system 50 according to the present invention. In the first step 132, a request is made to assemble a product at the assembly station 65. The control system 82 determines the parts or items needed to assemble the product at the assembly station 65. This involves determining the unique identification 92a of the storage containers containing the items from Grid A at step 134. As discussed above, the unique identification 92 is associated with the product to be assembled at the assembly station 65. The unique identification 92 comprises data associated with the grid location of the storage containers 9 containing the respective assembly items. Once all of the items or parts have been identified, the control system 82 instructs one or more load handling devices 31 operative on the track system 13 of Grid A to retrieve the storage containers 9 containing the respective items at step 136. The load handling devices 31 transport the storage containers 9 to the at least one port column 58 of Grid A, and the storage containers 9 are subsequently transferred to the at least one transfer system 56. Labels comprising information of the unique identification 92 from the storage containers 9) at the at least one transfer system 56 are scanned or inputted into the control system 82. The control system 82 determines at step 138 whether all of the parts or items at the assembly station 65 are present to assemble the product. If not, then the control system 82 identifies the missing items or parts and instructs one or more load handling devices 31 to retrieve them from Grid A. If all of the items are present, then the items are consolidated for assembly at the assembly station 65 at step 140.

Like the pick station 64 described above, assembly of the items can be by a manual operation or an automated operation. For example, the automated operation can involve one or more robotic arms 76 carrying out automated assembly steps such as welding, fixing, placing etc. The assembled product at the assembly station 65 is then transferred to Grid B for storage. The control system 82 can be instructed to retrieve one or more storage containers 9 with a corresponding unique identification to the assembled product at the assembly station at step 122 and move the one or more storage containers 9 to the buffer zone 70. The assembled product is transferred to the storage container 9 at the buffer zone 70 at step 124. The transfer can also involve scanning a label on the storage container 9 at the buffer zone 70 and inputting the information from the label in to the control system 82. The information on the label includes the unique identification of the storage container at the buffer zone 70, and the information is subsequently stored in a database 94b (Grid B database). The unique identification 92b is a record of the assembled product and its respective grid location in storage in Grid B. A load handling device 31 operative on the track system 13 of Grid B transfers the storage container 9) from the buffer zone 70 to a grid location in Grid B. The grid location is assigned to the unique identification 92b of the storage container in Grid B. This process of assembly of one or more items from Grid A, assembly at the assembly station 65, and storage of the assembled product in Grid B repeats for the other items in Grid A. Thus. Grid A provides parts of an assembled product and Grid B provides the storage for the assembled product. The at least one transfer system 56 linking Grid A and Grid B together provides the necessary stations to link Grid A with Grid B.

The advantage of the automated load handling system 50 according to the present invention is that the process of sortation and/or collation or consolidation of one or more items can be automated. The bottleneck as a result of manual sortation and/or consolidation of one or more items can be automated, making the process of sortation and/or consolidation a much faster process. A plurality of transfer systems 56 can work in tandem to sort and/or collate one or more items having different unique identifications 92, e.g. different flight details in the case of an automated baggage handling system, from the first automated storage and retrieval system 52 to a second automated storage and retrieval system 54. Moreover, the use of a grid framework structure 1 to hold storage containers 9 allows a high density of storage containers to be held for a given footprint of the storage facility.

### Definitions

It is envisaged that any one or more of the variations described in the foregoing paragraphs may be implemented in the same embodiment of an automated handling system.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

1. An automated load handling system, comprising:
A) first and second automated storage and retrieval systems, of the first and the second automated storage and retrieval systems including:
i) a grid framework structure including:
a) a track system including a first set of parallel tracks, and a second set of parallel tracks running transversely to the first set in a substantially horizontal plane, and arranged in a grid pattern having a plurality of grid cells, each grid cell defining a grid opening defined by a pair of adjacent tracks of the first set of parallel tracks and a pair of adjacent tracks of the second set of parallel tracks;
b) a plurality of storage columns, each storage column being configured and arranged to store a respective stack of storage containers for storing one or more items, wherein each stack of storage containers is located beneath the track system such that each stack of storage containers occupies a single or grid cell;
ii) a plurality of robotic load handling devices operative on the track system and configured for lifting and moving one or more storage containers from a stack;
B) at least one port column extending downwardly from a grid opening of the track system of each of the first and the second automated storage and retrieval systems through which a respective robotic load handling device operative on the track system is able to drop off and pick up one or more storage containers; and
C) at least one transfer system configured to transfer one or more storage containers or one or more items from the storage containers from the at least one port column of the first automated storage and retrieval system to the at least one port column of the second automated storage and retrieval system; and
wherein the grid opening of the track system of the first automated storage and retrieval system is a different size relative to the grid opening of the track system of the second automated storage and retrieval system such that the grid framework structure of the first automated storage and retrieval system is configured to store storage containers that are differently sized to the storage containers stored in the grid framework structure of the second automated storage and retrieval system.

2. The automated load handling system of claim 1, wherein the grid opening of the track system of the first automated storage and retrieval system is smaller than the grid opening of the track system of the second automated storage and retrieval system such that the grid framework structure of the first automated storage and retrieval system, is configured to store smaller storage containers than the storage containers stored in the grid framework structure of the second automated storage and retrieval system.

3. The automated load handling system of claim 1, wherein the at least one port column of each of the grid framework structures of the first and the second automated storage and retrieval systems comprises:
an inlet port column for receiving one or more storage containers transferred from the at least one transfer system, and
an outlet port column for dropping off one or more storage containers to the least one transfer system.

4. The automated load handling system of claim 3, wherein the at least one transfer system comprises:
at least one conveyor system including at least one conveyor unit extending from the outlet port column of the grid framework structure of the first or second automated storage and retrieval system to the inlet port column of the grid framework structure of the first or second automated storage and retrieval system so as to transport one or more storage containers into and out of their respective grid framework structures.

5. The automated load handling system of claim 1, wherein the at least one transfer system comprises,
at least one conveyor system including at least one conveyor unit extending from the at least one port column of the grid framework structure of the first automated storage and retrieval system to the at least one port column of the grid framework structure of the second automated storage and retrieval system so as to transport one or more storage containers from the first automated storage and retrieval system to the second automated storage and retrieval system.

6. The automated load handling system of claim 3, wherein the at least one transfer system comprises:
at least one conveyor system including a first conveyor system arranged for transporting one or more storage container into and out of the grid framework structure of the first automated storage and retrieval system; and
a second conveyor system arranged for transporting one or more storage container into and out of the grid framework structure of the second automated storage and retrieval system.

7. The automated load handling system of claim 6, wherein the at least one conveyor system comprises,
an entry conveyor unit;
an exit conveyor unit; and
a transfer conveyor unit, the exit conveyor unit being configured and arranged to transport a storage container in a first direction to the transfer conveyor unit from the outlet port column, and the entry conveyor unit being configured and arranged to transport a storage container in a second direction to the inlet port column from the transfer conveyor unit.

8. The automated load handling system of claim 7, wherein the transfer conveyor unit is configured and arranged to transport a storage container in a third direction.

9. The automated load handling system of claim 8, wherein the exit conveyor unit and the entry conveyor unit are configured and arranged such that the first direction of the exit conveyor unit is opposite and parallel to the second direction of the entry conveyor unit and wherein the third direction of the transfer conveyor unit, is substantially orthogonal to both the first direction of the exit conveyor unit and the second direction of the entry conveyor unit.

10. The automated load handling system of claim 7, wherein the at least one transfer system comprises:
a buffer zone configured and arranged for holding one or more storage containers at the transfer conveyor unit of the first and/or second automated storage and retrieval system.

11. The automated load handling system of claim 10, wherein the at least one transfer system comprises:
a pick station configured for receiving storage containers dropped off from the at least one port column of the grid framework structure of the first automated storage and retrieval system.

12. The automated load handling system of claim 11, wherein the pick station comprises:
a robotic arm configured for transferring one or more items from one or more storage containers from the first automated storage and retrieval system to one or more storage containers at the transfer conveyor unit of the second automated storage and retrieval system.

13. The automated load handling system of claim 11, wherein the pick station comprises:
a tilting mechanism configured for tilting the storage container; and
a slide adjacent the tilting mechanism configured for capturing one or more items exiting the tilting mechanism.

14. The automated load handling system of claim 1, comprising:
storage containers of the first automated storage and retrieval system which include shallow trays mounted on spacing means to vertically space the shallow trays from one another in the stacks in the grid framework structure of the first automated storage and retrieval system.

15. The automated load handling system of claim 14, wherein each of the shallow trays comprises:
a bottom wall; and
an upwardly extending rim including one or more cutouts, configured for one or more items inside the shallow tray to be accessed when the shallow trays are stored in stacks in the grid framework structure of the first automated storage and retrieval system.

16. The automated load handling system of claim 1, wherein the at least one transfer system comprises:
at least one assembly station configured for assembling one or more items from one or more storage containers from the first automated storage and retrieval system.

17. The automated load handling system of claim 1, wherein each load handling device of the plurality of load handling devices of the first and the second automated storage and retrieval systems comprises:
a lifting mechanism including a grabber device configured to releasably engage with a storage container and
a winch mechanism configured to lift the storage container above the track system.

18. The automated load handling system of claim 1, further comprising:
a control system configured to include one or more processors and memory storing instructions, that when executed by the one or more processors, cause the control system to:
a) receive a request for storage of an item associated with a user or at least a portion of a product;
b) to generate a unique identification including data associated with the user or the at least portion of the product;
c) assign the unique identification to a storage container in the first automated storage and retrieval system; and
d) store data associated with the unique identification in a database.

19. The automated load handling system of claim 18, wherein the unique identification is assigned to a storage container in the first automated storage and retrieval system to correlate a grid location of the storage container in the grid framework structure of the first automated storage and retrieval system to the unique identification.

20. The automated load handling system of claim 18, wherein the control system is configured to:
a) generate a unique identification including data associated with each storage container in the second automated storage and retrieval system; and
b) assign the unique identification of the storage container to a grid location of the storage container in the grid framework structure of the second automated storage and retrieval system.

21. The automated load handling system of claim 20, wherein the control system is configured to:
consolidate or collate a plurality of items from one or more storage containers in the first storage and retrieval system for transfer to a storage container in the grid framework structure of the second automated storage and retrieval system based on their respective unique identification.

22. The automated load handling system of claim 21, wherein the control system is configured to:
consolidate or collate the plurality of items from one or more storage containers in the first storage and retrieval system by consolidating their respective unique identification associated with one or more users or at least a portion of a product.

23. The automated load handling system of claim 22, wherein the control system is configured to:
assign the consolidated unique identification associated with one or more users or the at least a portion of a product to a unique identification of the storage container of the second automated storage and retrieval system.

24. The automated load handling system of claim 23, wherein the control system is configured to:
instruct one or more load handling devices operative on the track system of the first automated storage and retrieval system to retrieve one or more storage containers based on a corresponding unique identification of the storage container of the second automated storage and retrieval system being at the at least one transfer system by:
i) correlating the unique identification associated with one or more users to the corresponding unique identification of the storage container of the second automated storage and retrieval system at the at least one transfer system;
ii) locating the one or more storage containers in the grid framework structure of the first automated storage and retrieval system based on correlating the unique identification to the grid location of the storage container in the grid framework structure of the first automated storage and retrieval system; and
iii) instructing one or more load handling devices operative on the track system of the first automated storage and retrieval system to retrieve the one or more storage containers from its grid location and move the one or more storage containers to the at least one port column of the first automated storage and retrieval system.

25. The automated load handling system of claim 18, wherein the automated handling system is configured to be:
an automated baggage handling system, with each of the one or more items stored in the one or more storage containers in the first automated storage and retrieval system being a baggage item, and the unique identification associated with a user is baggage tag data, said baggage tag data including data associated with a user specified destination, together with booking data indicating travel data, and wherein each of the one or more storage containers in the second automated storage and retrieval system is a unit load device (ULD).

26. The automated load handling system of claim 21, wherein at least a portion of the product comprises:
an assembly of the consolidated or collated plurality of items.

27. The automated load handling system of claim 26, wherein the control system is configured to,
instruct one or more load handling devices operative on the track system of the first automated storage and retrieval system to retrieve one or more storage containers to its respective port column based on a unique identification associated with the at least a portion of the product by:
i) identifying one or more storage containers including one or more items, each of the one or more items forming part of the at least portion of the product;
ii) locating the one or more storage containers in the grid framework structure of the first automated storage and retrieval system based on correlating the unique identification to the grid location of the storage container in the grid framework structure of the first automated storage and retrieval system; and
iii) instructing one or more load handling devices operative on the track system of the first automated storage and retrieval system to retrieve the one or more storage containers from its grid location and move the one or more storage containers to the at least one port column of the first automated storage and retrieval system, each of the one or more storage containers including one or more items for assembly into at least a portion of the product.

28. A method of handling one or more items in an automated load handling system having first and second automated storage and retrieval systems, in response to one or more storage containers from the second automated storage and retrieval system being at the at least one transfer system, the method comprising:
i) identifying one or more storage containers including one or more items by correlating a unique identification associated with one or more users from the first automated storage and retrieval system to a unique identification of the one or more storage containers from the second automated storage and retrieval system at the at least one transfer system;
ii) instructing one or more load handing devices operative on a track system of the first automated storage and retrieval system to retrieve the one or more identified storage containers and move the one or more storage containers to at least one port of a grid framework structure of the first storage and retrieval system;
iii) transferring one or more items from the identified one or more storage containers to the one or more storage containers from the second automated storage and retrieval system at the at least one transfer system;
iv) instructing one or more load handing devices operative on a track system of the second automated storage and retrieval system to move the one or more storage containers from the at least one transfer system to a storage column of the grid framework structure of the second automated storage and retrieval system.

29. The method of claim 28, comprising:
instructing one or more load handing devices operative on the track system of the second automated storage and retrieval system to retrieve one or more storage containers from the grid framework structure of the second automated storage and retrieval system to the at least one transfer system based on the unique identification of the one or more identified storage containers from the first automated storage and retrieval system.

30. A method of claim 28, for assembling one or more items from the automated load handling system to form at least a portion of a product, the method comprising:
i) identifying one or more storage containers including one or more items having a unique identification associated with the at least portion of the product from the first automated storage and retrieval system;
ii) instructing one or more load handling devices operative on the track system of the first automated storage and retrieval system to retrieve the one or more storage containers from its grid location and move the one or more storage containers to the at least one port column of the first automated storage and retrieval system, each of the one or more storage containers including one or more items for assembly into the at least a portion of the product;
iii) assembling the one or more items from the one or more storage containers to form the at least a portion of the product;
iv) transferring the at least a portion of the product to the one or more storage containers from the second automated storage and retrieval system at the at least one transfer system; and
v) instructing one or more load handing devices operative on the track system of the second automated storage and retrieval system to move the one or more storage containers from the at least one transfer system to a storage column of the grid framework structure of the second automated storage and retrieval system.
